(19) United States
(12) Patent Application Publication
(10) Pub. No.: US 2011/0086623 A1
(43) Pub. Date: Apr. 14, 2011

(54) METHOD AND SYSTEM FOR PROVIDING CONTACT INFORMATION FOR MOBILE COMMUNICATION DEVICE USERS

(75) Inventors: James D. Patterson, Kansas City, MO (US); David Bottoms, Overland Park, KS (US); Michael Rapken, Kansas City, MO (US); Thomas C. Ely, Bridgewater, NJ (US); Sue E. Brothers, Olathe, KS (US); Jay Scott Harmon, Leawood, KS (US)

(73) Assignee: MOBILE SYMMETRY, LLC, Fairway, KS (US)

(21) Appl. No.: 12/901,095

(22) Filed: Oct. 8, 2010

Related U.S. Application Data
(60) Provisional application No. 61/250,351, filed on Oct. 9, 2009.
(60) Provisional application No. 61/312,992, filed on Mar. 11, 2010.
(60) Provisional application No. 61/312,996, filed on Mar. 11, 2010.
(60) Provisional application No. 61/312,998, filed on Mar. 11, 2010.

(51) Int. Cl. H04W 4/00

(52) U.S. Cl. 455/414.2

(57) ABSTRACT

A method and system for providing cross-carrier contact information for mobile users of mobile communication devices and other mobile communication devices provides a single registry of user profiles, wherein each user profile is established and maintained by a user so that each user may control how and by whom they are contacted. The registry of user profiles may be accessed with a client software application on a calling party's mobile communication device. The calling party may transmit a look-up request to the registry over a data channel. The registry receives the look-up request and locates a user profile that matches the look-up request and provides the user profile to the calling mobile communication device. The user profile does not display the mobile communication device number for the called mobile communication device. Once the calling party calls the called party, the called mobile communication device may query the registry and display the user profile for the calling mobile communication device.

### RELATED APPLICATIONS

The present application claims the priority benefit of U.S. Provisional Patent Application Ser. No. 61/250,351 entitled “CALLING NAME DIRECTORY SERVICE AND METHOD FOR MOBILE COMMUNICATIONS DEVICES,” filed Oct. 9, 2009; U.S. Provisional Patent Application Ser. No. 61/312,992 entitled “METHOD AND SYSTEM FOR CREATING AND SHARING PERSONAL INFORMATION VIA USER-CREATED PROFILES FOR CELL PHONE DIRECTORIES,” filed Mar. 11, 2010; U.S. Provisional Patent Application Ser. No. 61/312,996 entitled “MOBILE AND ONLINE MICRO DIRECTORY FOR CELL PHONES AND OTHER MOBILE COMMUNICATIONS DEVICES,” filed Mar. 11, 2010; and U.S. Provisional Patent Application Ser. No. 61/312,998 entitled “CALLING NAME DIRECTORY SERVICE AND METHOD FOR MOBILE COMMUNICATIONS DEVICES WITH PREDICTIVE PATTERN ANALYSIS,” filed Mar. 11, 2010, the entire disclosures of which are incorporated herein by reference.

### BACKGROUND

The present invention relates to wireless communications. More particularly, the invention relates to a method and system for providing contact information for mobile communication device users.

Mobile communication device use continues to increase worldwide. Many people now use mobile communications exclusively and have discontinued landline service altogether. Some developing countries do not even install landline communication infrastructure in certain areas because mobile communication device infrastructure is less expensive and more scaleable.

One impediment to mobile communication device usage is the difficulty in obtaining contact information for mobile communication devices. Mobile communication services are typically provided by numerous different wireless carriers, each of which maintains contact information for its own customers but not other carriers' customers. Thus, a user wishing to find the phone number for a mobile communication device user must first know the user's carrier.

Even when a user's carrier is known, it may refuse to provide phone numbers for its subscribers to prevent sales calls and other unwanted calls and texts. Because many mobile communication device subscribers have pre-set limits on voice calls and text messages and pay per-minute or per-message charges when these limits are exceeded, unwanted phone calls and texts are a bigger issue for mobile communications than landline communications.

Many mobile directory services and systems have been developed and/or proposed to provide contact information for mobile communication device users, but none have been widely adopted due to various limitations. Accordingly, there is a need for an improved method and system for providing contact information for mobile communication device users that overcomes the limitations of the prior art.

### SUMMARY

The present invention solves the above-described problems and provides a distinct advance in the art of wireless communications. More particularly, the present invention provides a method and system for providing cross-carrier contact information for mobile communication device users while allowing the users to control how and by whom they are contacted.

An embodiment of the invention achieves the foregoing by providing a central registry of user profiles established and maintained by mobile communication device users. Each user profile may include, among other information, a mobile communication device user's name and mobile communication device number and permission information that enables the user to select how and by whom they are contacted. Importantly, the user profile owners themselves control the content and appearance of their user profiles and decide how they wish to be contacted, if at all.

An embodiment of the invention also includes a client software application that may be loaded on the mobile communication device of each user who wishes to access the registry of user profiles. The client software application includes a look-up function that permits a user to enter a name and/or other identifying information for a person the user wishes to call and to transmit a corresponding look-up request to the registry. Importantly, the look-up request is transmitted from the requesting mobile communication device to the registry over a data channel independent of a subsequent voice channel established between the requesting mobile communication device and the called mobile communication device. Alternatively, mobile communication devices or other electronic devices without the client software application may launch a browser and access the registry via a WAP site to search for user profiles.

Once the registry receives a look-up request, it searches the user profiles, locates a user profile that matches the look-up request, and provides the user profile to the requesting mobile communication device. The client software application on the requesting mobile communication device then displays the user profile owner's name and other information but does not display the user profile owner's phone number. The requesting party may then click on links in the user profile to contact the user profile owner via any of the user profile owner's allowed communication methods (e.g. mobile communication device call, text, e-mail). The user profile may also require the requestor to seek permission before contacting the user profile owner directly.

As the requesting mobile communication device (also referred to as the “calling mobile communication device”) calls the mobile communication device associated with the user profile (also referred to as the “called mobile communication device”), the called mobile communication device queries the registry for the user profile of the calling mobile communication device and displays the user profile. This enables the called party to view the user profile of the calling party as the phone call is being established between the parties. As with the look-up request transmitted to the registry from the calling mobile communication device, the query from the called mobile communication device to the registry is sent over a data channel.

Users may also store links to one or more user profiles in a personal directory on their mobile communication devices. A personal directory includes the name or other identifier for a user profile that links to a full user profile stored on the registry. This permits users to more quickly locate user profiles for frequently contact persons.

The present invention provides numerous advantages over existing prior art mobile directory services and systems. For example, by providing a central registry of user profiles, users can quickly and easily obtain contact information for anyone, regardless of their wireless carrier. Moreover, because the user profiles in the registry can be searched by name, callers can contact others without knowing their mobile communication device numbers and users can be called without disclosing their phone numbers.

Moreover, the features of the present invention may be implemented with the assistance of one or more mobile carriers or may be implemented without direct carrier involvement.

The invention also eliminates the need for users to create, maintain, and update their own contact lists because updated user profiles can be obtained from the registry. For example, if a user changes a phone number or other information in his or her user profile, everyone who uses the registry to contact that person will automatically have access to the updated user profile without updating their own personal contact lists. The invention also allows users to manage the contents and appearance of their user profiles and control how and by whom they are contacted.

The invention also provides mobile communication device users other valuable information such as in-network call indicators and “calling reason” indicators as described in more detail below.

Importantly, the registry of user profiles and all other features of the present invention are fully compliant with the Children's Online Privacy Protection Act (COPPA) and similar pending proposals for minors (children are under 13 years of age, minors are between 13-18). All child and minor profile information is protected starting with the initial requests for information from the child/minor, through the gathering of the information, and to the storing and access of the information. For example, a child is only allowed to have a private view as defined below, whereas a minor may have a public view and a private view. For a child profile, one or more responsible adults must be designated, and the responsible adult(s) must approve the child's profile before it is posted, all views of the profile, which directories the child opts into, and any changes to the profile. Similar protections are provided for minor profiles, except with a minor profile, the responsible adult(s) may approve the initial profile and then may elect to either approve all profile changes and directory access or just be notified of the same.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram of exemplary computer and communications equipment that may be used to implement embodiments of the present invention.

FIG. 2a is a flow chart depicting certain steps in one or more methods of the present invention and/or the functionality of certain code segments of one or more computer programs of the present invention.

FIG. 2b is a continuation of the flow chart of FIG. 2a.

FIG. 3 is another flow chart depicting certain steps in one or more methods of the present invention and/or the functionality of certain code segments of one or more computer programs of the present invention.

FIG. 4a is another flow chart depicting certain steps in one or more methods of the present invention and/or the functionality of certain code segments of one or more computer programs of the present invention.

FIG. 4b is a continuation of the flow chart of FIG. 4a.

FIG. 5 is another flow chart depicting certain steps in one or more methods of the present invention and/or the functionality of certain code segments of one or more computer programs of the present invention.

FIG. 6a is another flow chart depicting certain steps in one or more methods of the present invention and/or the functionality of certain code segments of one or more computer programs of the present invention.

FIG. 6b is a continuation of the flow chart of FIG. 6a.

FIG. 7 is an exemplary screen shot that may be displayed by a mobile communication device or other electronic device while implementing one of the methods of the present invention and/or the computer programs of the present invention.

FIG. 8 is another exemplary screen shot that may be displayed by a mobile communication device or other electronic device while implementing one of the methods of the present invention and/or the computer programs of the present invention.

FIG. 9 is another exemplary screen shot that may be displayed by a mobile communication device or other electronic device while implementing one of the methods of the present invention and/or the computer programs of the present invention.

FIG. 9a is another exemplary screen shot that may be displayed by a mobile communication device or other electronic device while implementing one of the methods of the present invention and/or the computer programs of the present invention.

FIG. 10 is another exemplary screen shot that may be displayed by a mobile communication device or other electronic device while implementing one of the methods of the present invention and/or the computer programs of the present invention.

FIG. 11 is another exemplary screen shot that may be displayed by a mobile communication device or other electronic device while implementing one of the methods of the present invention and/or the computer programs of the present invention.

FIG. 12 is another exemplary screen shot that may be displayed by a mobile communication device or other electronic device while implementing one of the methods of the present invention and/or the computer programs of the present invention.

FIG. 13 is another exemplary screen shot that may be displayed by a mobile communication device or other electronic device while implementing one of the methods of the present invention and/or the computer programs of the present invention.

FIG. 14 is another exemplary screen shot that may be displayed by a mobile communication device or other electronic device while implementing one of the methods of the present invention and/or the computer programs of the present invention.

FIG. 15 is another exemplary screen shot that may be displayed by a mobile communication device or other electronic device while implementing one of the methods of the present invention and/or the computer programs of the present invention.

FIG. 16 is another exemplary screen shot that may be displayed by a mobile communication device or other electronic device while implementing one of the methods of the present invention and/or the computer programs of the present invention.

FIG. 17 is another exemplary screen shot that may be displayed by a mobile communication device or other electronic device while implementing one of the methods of the present invention and/or the computer programs of the present invention.

FIG. 18 is another exemplary screen shot that may be displayed by a mobile communication device or other electronic device while implementing one of the methods of the present invention and/or the computer programs of the present invention.

FIG. 19 is another exemplary screen shot that may be displayed by a mobile communication device or other electronic device while implementing one of the methods of the present invention and/or the computer programs of the present invention.

FIG. 20 is another exemplary screen shot that may be displayed by a mobile communication device or other electronic device while implementing one of the methods of the present invention and/or the computer programs of the present invention.

FIG. 21 is another exemplary screen shot that may be displayed by a mobile communication device or other electronic device while implementing one of the methods of the present invention and/or the computer programs of the present invention.

FIG. 22 is another exemplary screen shot that may be displayed by a mobile communication device or other electronic device while implementing one of the methods of the present invention and/or the computer programs of the present invention.

FIG. 22a is another exemplary screen shot that may be displayed by a mobile communication device or other electronic device while implementing one of the methods of the present invention and/or the computer programs of the present invention.

FIG. 23 is another exemplary screen shot that may be displayed by a mobile communication device or other electronic device while implementing one of the methods of the present invention and/or the computer programs of the present invention.

FIG. 24 is another exemplary screen shot that may be displayed by a mobile communication device or other electronic device while implementing one of the methods of the present invention and/or the computer programs of the present invention.

FIG. 25 is another exemplary screen shot that may be displayed by a mobile communication device or other electronic device while implementing one of the methods of the present invention and/or the computer programs of the present invention.

FIG. 26 is another exemplary screen shot that may be displayed by a mobile communication device or other electronic device while implementing one of the methods of the present invention and/or the computer programs of the present invention.

FIG. 27 is another exemplary screen shot that may be displayed by a mobile communication device or other electronic device while implementing one of the methods of the present invention and/or the computer programs of the present invention.

FIG. 28 is another exemplary screen shot that may be displayed by a mobile communication device or other electronic device while implementing one of the methods of the present invention and/or the computer programs of the present invention.

FIG. 29 is another exemplary screen shot that may be displayed by a mobile communication device or other electronic device while implementing one of the methods of the present invention and/or the computer programs of the present invention.

FIG. 30 is another exemplary screen shot that may be displayed by a mobile communication device or other electronic device while implementing one of the methods of the present invention and/or the computer programs of the present invention.

FIG. 31 is another exemplary screen shot that may be displayed by a mobile communication device or other electronic device while implementing one of the methods of the present invention and/or the computer programs of the present invention.

FIG. 32 is another exemplary screen shot that may be displayed by a mobile communication device or other electronic device while implementing one of the methods of the present invention and/or the computer programs of the present invention.

FIG. 33 is another exemplary screen shot that may be displayed by a mobile communication device or other electronic device while implementing one of the methods of the present invention and/or the computer programs of the present invention.

FIG. 34 is another exemplary screen shot that may be displayed by a mobile communication device or other electronic device while implementing one of the methods of the present invention and/or the computer programs of the present invention.

FIG. 35 is another exemplary screen shot that may be displayed by a mobile communication device or other electronic device while implementing one of the methods of the present invention and/or the computer programs of the present invention.

FIG. 36 is another exemplary screen shot that may be displayed by a mobile communication device or other electronic device while implementing one of the methods of the present invention and/or the computer programs of the present invention.

FIG. 37 is another exemplary screen shot that may be displayed by a mobile communication device or other electronic device while implementing one of the methods of the present invention and/or the computer programs of the present invention.

FIG. 38 is another exemplary screen shot that may be displayed by a mobile communication device or other electronic device while implementing one of the methods of the present invention and/or the computer programs of the present invention.

FIG. 39 is another exemplary screen shot that may be displayed by a mobile communication device or other electronic device while implementing one of the methods of the present invention and/or the computer programs of the present invention.

FIG. 40 is another exemplary screen shot that may be displayed by a mobile communication device or other electronic device while implementing one of the methods of the present invention and/or the computer programs of the present invention.

FIG. 41 is another exemplary screen shot that may be displayed by a mobile communication device or other electronic device while implementing one of the methods of the present invention and/or the computer programs of the present invention.

FIG. 42 is another exemplary screen shot that may be displayed by a mobile communication device or other electronic device while implementing one of the methods of the present invention and/or the computer programs of the present invention.

FIG. 43 is another exemplary screen shot that may be displayed by a mobile communication device or other electronic device while implementing one of the methods of the present invention and/or the computer programs of the present invention.

FIG. 44 is another exemplary screen shot that may be displayed by a mobile communication device or other electronic device while implementing one of the methods of the present invention and/or the computer programs of the present invention.

FIG. 45 is another exemplary screen shot that may be displayed by a mobile communication device or other electronic device while implementing one of the methods of the present invention and/or the computer programs of the present invention.

FIG. 46 is another exemplary screen shot that may be displayed by a mobile communication device or other electronic device while implementing one of the methods of the present invention and/or the computer programs of the present invention.

FIG. 47 is another exemplary screen shot that may be displayed by a mobile communication device or other electronic device while implementing one of the methods of the present invention and/or the computer programs of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

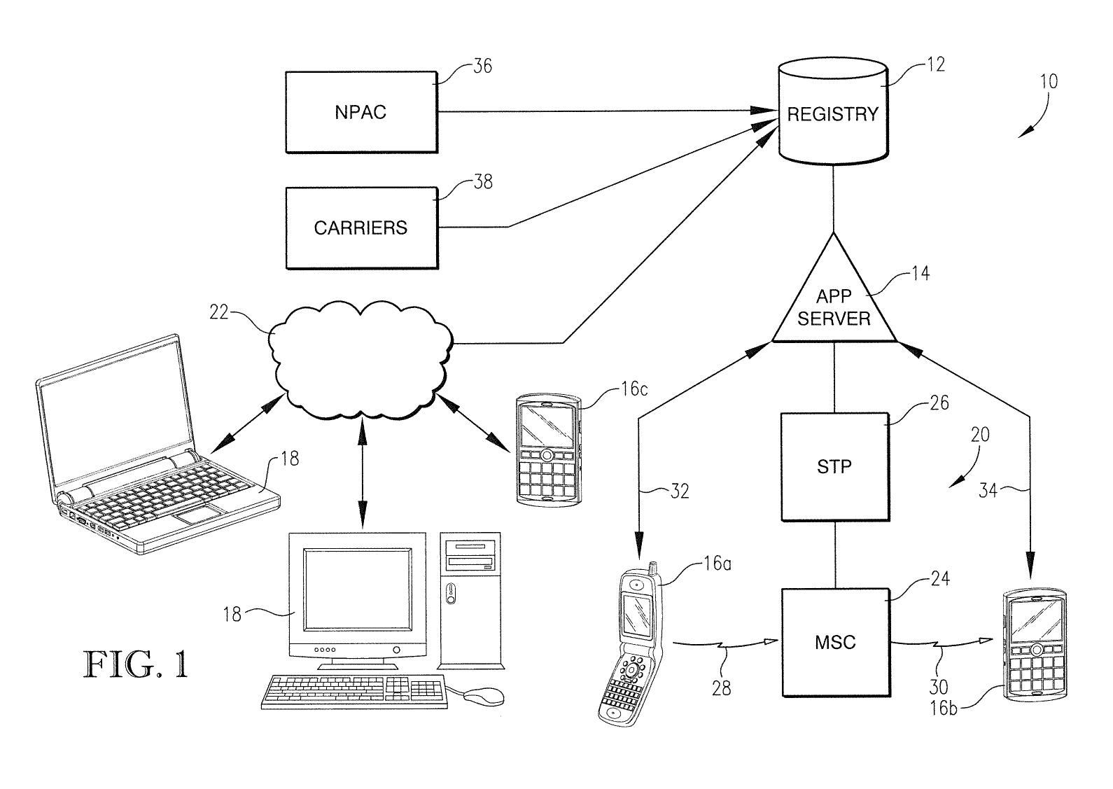

Embodiments of the present invention can be implemented in hardware, software, firmware, or a combination thereof In one embodiment, the invention is implemented with computer and communications equipment broadly referred to by the numeral 10 in FIG. 1. The computer and communications equipment 10 includes a central registry 12, one or more application servers 14, a plurality of mobile communications devices 16, one or more computing devices 18, a wireless telecommunications network 20, and a communications network 22. The components of the computer and communication equipment 10 illustrated and described herein are merely examples of equipment that may be used to implement embodiments of the present invention and may be replaced with other equipment without departing from the scope of the present invention.

In more detail, the central registry 12 serves as a repository for user profiles and programs used to implement certain aspects of the present invention as described in more detail below. The central registry 12 may include one or more servers running Windows; LAMP (Linux, Apache HTTP server, MySQL, and PHP/Perl/Python); Java; AJAX; NT; Novel Netware; Unix; or any other software system and includes or has access to computer memory and other hardware and software for receiving, storing, accessing, and transmitting user profiles and related requests as described below. The central registry also includes conventional web hosting operating software, searching algorithms, an Internet connection, and is assigned a URL and corresponding domain name such as “mobilesymmetry.com” so that a website hosted thereon can be accessed via the Internet in a conventional manner.

The application servers 14 are provided to distribute the data stored on the central registry 12, if necessary, so that the central registry is not over-burdened with user profile requests and other functions. Thus, the number of application servers 14 required depends on the number of user profiles stored in the central registry 12 and the number of look-up requests and other requests received by the central registry 12. In some embodiments, many application servers 14 may be needed, and in other embodiments, only one or even no application servers 14 may be needed. As with the central registry 12, each application server 14 may include one or more servers running Windows NT, Novel Netware, Unix, or any other network operating system and includes or has access to computer memory and other hardware and software for receiving, storing, accessing, and transmitting user profiles and related requests as described below. Each application server 14 may also include conventional web hosting operating software, searching algorithms, an Internet connection, and a URL and corresponding domain name so that a website hosted thereon can be accessed via the Internet in a conventional manner. The application servers may also host and support software and services of proprietary mobile application providers such as Google, Apple, and Blackberry.

The mobile communication devices 16 may be any type of devices that can make and receive wireless communications such as phone calls, SMS texts, MMS messages, SMTP messages, etc. via the wireless telecommunication network 20. The mobile communication device 16 may include, for example, wireless phones, phone-enabled personal digital assistants, phone-enabled MP3 devices, phone-enabled handheld game players, or any other wireless communication device. In current embodiments of the invention, the mobile communication devices are “smart” phones such as those manufactured by Apple®, Blackberry® , or Motorola®. Each mobile communication device 16 preferably includes or can access an Internet browser and a conventional Internet connection such as a wireless broadband connection, a modem, DSL converter, or ISDN converter so that it can access the central registry 12 via the communications network 22.

Any number of mobile communication devices 16 may use the directory services of the present invention. For simplicity only three mobile communication devices are shown in FIG. 1, a mobile communication device 16a that submits a look-up request to the registry 12 and makes a phone call, a mobile communication device 16b that receives the phone call from the mobile communication device 16a and submits a query to the registry, and a mobile communication device 16c that submits information and look-up requests to the registry via the communication network 22.

The computing devices 18 may be any devices that can access the central registry 12 via the communications network 22. For example, the computing devices may be laptop, desktop or other personal computers such as those manufactured by Macintosh®, Dell®, or Toshiba®. As with the mobile communication devices 16, each computing device 18 includes or can access an Internet browser and a conventional Internet connection such as a wireless broadband connection, a modem, DSL converter, or ISDN converter so that it can access the central registry via the communications network.

The wireless telecommunication network 20 may be any communication network capable of supporting wireless communications between the mobile communication devices 16 such as the wireless networks operated by AT&T, Verizon, or Sprint. The wireless telecommunication network 20 includes conventional switching and routing equipment, but for simplicity, only a mobile switching center (MSC) 24 and signal transfer point (STP) 26 serving a terminating or called mobile communication device are illustrated in FIG. 1.

The wireless telecommunication network 20 establishes voice channels 28, 30 between the mobile communications devices 16a, 16b and the MSC 24 and data channels 32, 34 between the mobile communication devices 16a, 16b and the registry 12.

The communications network 22 is preferably the Internet but may be any other communications network such as a local area network, a wide area network, a wireless network, or an intranet. The communications network 22 may also be a combination of several networks.

The computer programs of the present invention are stored in or on computer-readable medium residing on or accessible by the registry 12, and the mobile communication devices 16. One embodiment of the invention includes one or more computer programs that implement functions and features of the invention on the registry 12 and a client software application that may be loaded on some or all of the mobile communication devices 16 for implementing functions and features of the invention on the mobile communication devices.

The computer programs preferably comprise ordered user profiles of executable instructions for implementing logical functions in their respective devices. The computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The above-described computer and communications equipment 10 and computer programs may be used to provide cross-carrier directory service features for mobile communication device users as described in detail below. In general, the registry 12 stores a plurality of user profiles, wherein each user profile is established and maintained by one of the users of the mobile communication devices 16 or computing devices 18. Each user profile includes, among other information, a user's name and phone number and permission information that enables the user to select how and by whom they are contacted.

A user wishing to obtain contact information for another user may enter a name and/or other identifying information into the client software application on his or her mobile communication device 16a and transmit a look-up request to the registry 12 or the application server 14. Importantly, the look-up request is transmitted from the mobile communication device 16 to the registry 12 over the data channel 32, not the voice channels 28, 30 between the mobile communication device 16a and the mobile communication device 16b.

Once the registry 12 receives the look-up request, it locates a user profile that matches the look-up request and provides the user profile to the requestor. The client software application on the requestor's mobile communication device displays the user profile owner's name and other identifying information but does not display the mobile communication device number. The requestor may initiate a call to the user profile owner by clicking on one of the allowed contact methods in the user profile or may be required to seek permission first as described in more detail below. Once the requestor (calling party) calls the user profile owner, the user profile owner's mobile communication device may query the registry for the calling party's user profile over the data channel 34. The registry then retrieves the user profile and provides it to the called mobile communication device for display thereon. When a client software application is not provided, the above steps may instead be performed via a personal computer and/or a WAP application.

Although embodiments of the invention described and illustrated herein primarily refer to directory services for mobile communication device calls, any wireless communications may be supported by the present invention including SMS text messages, multi-media message service (MMS) messages, SMTP messages, Skype, and e-mail.

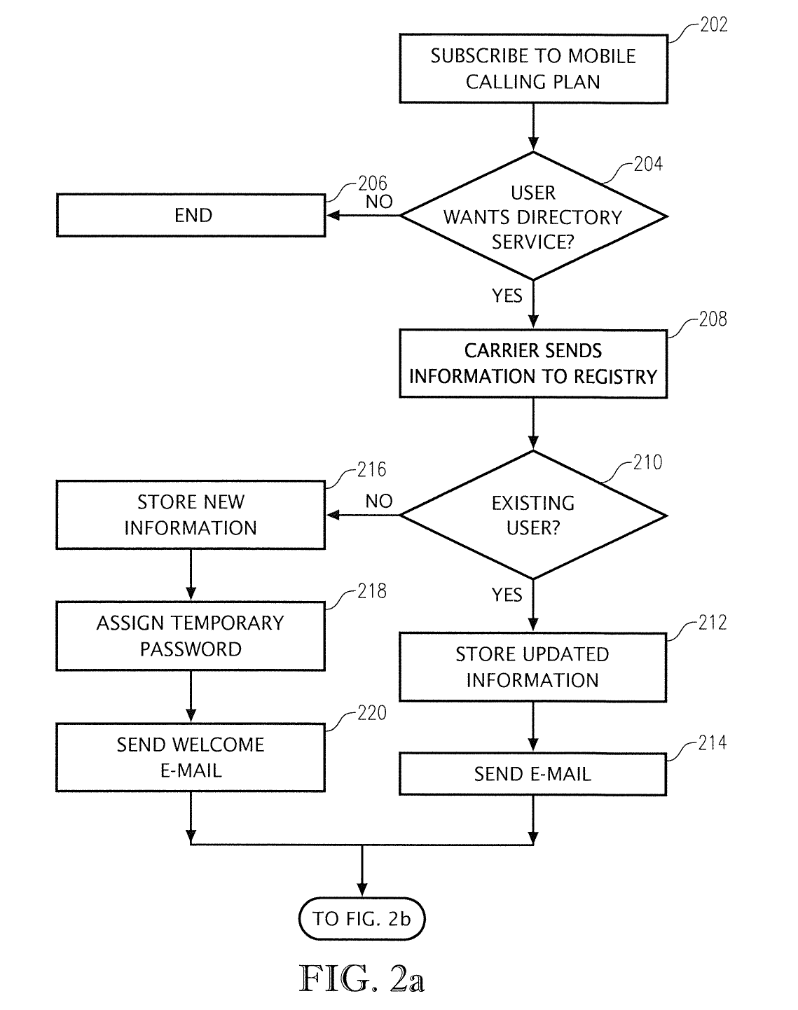

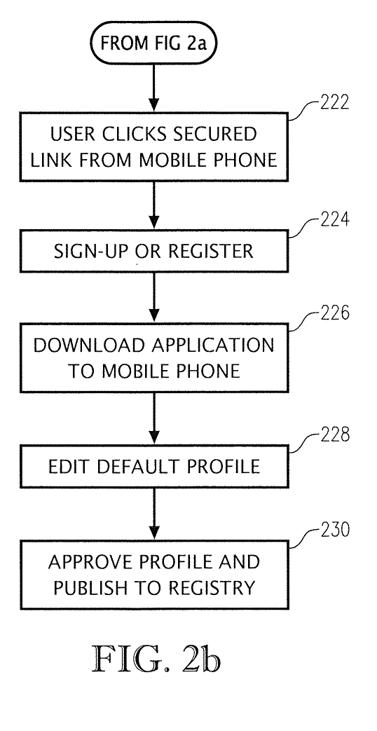

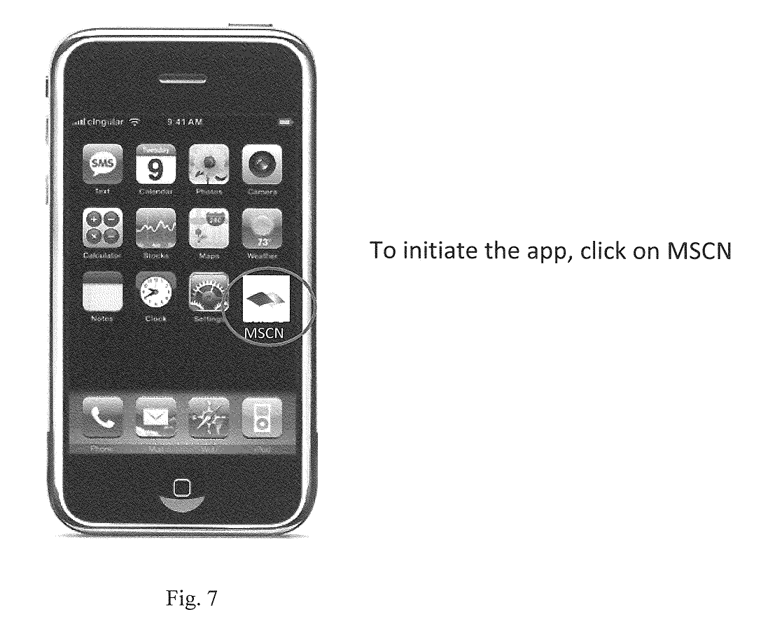

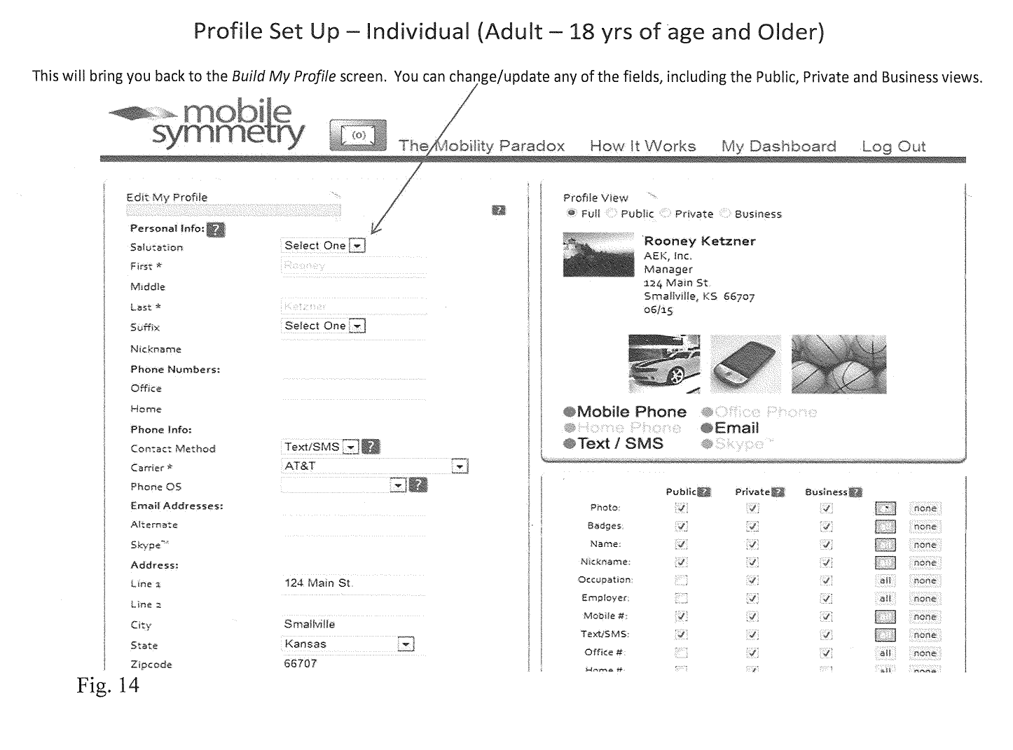

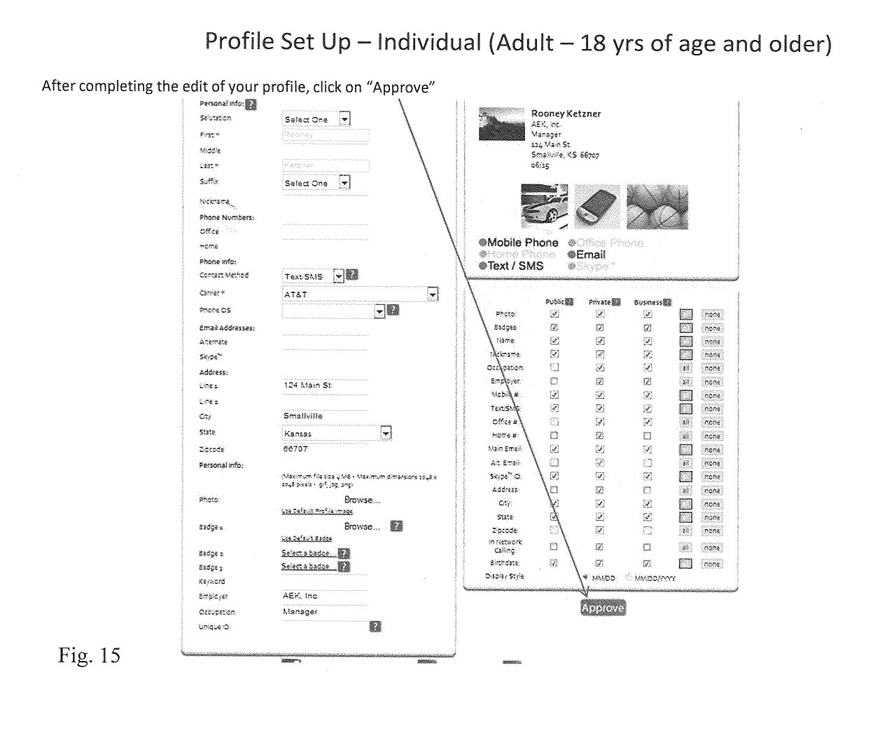

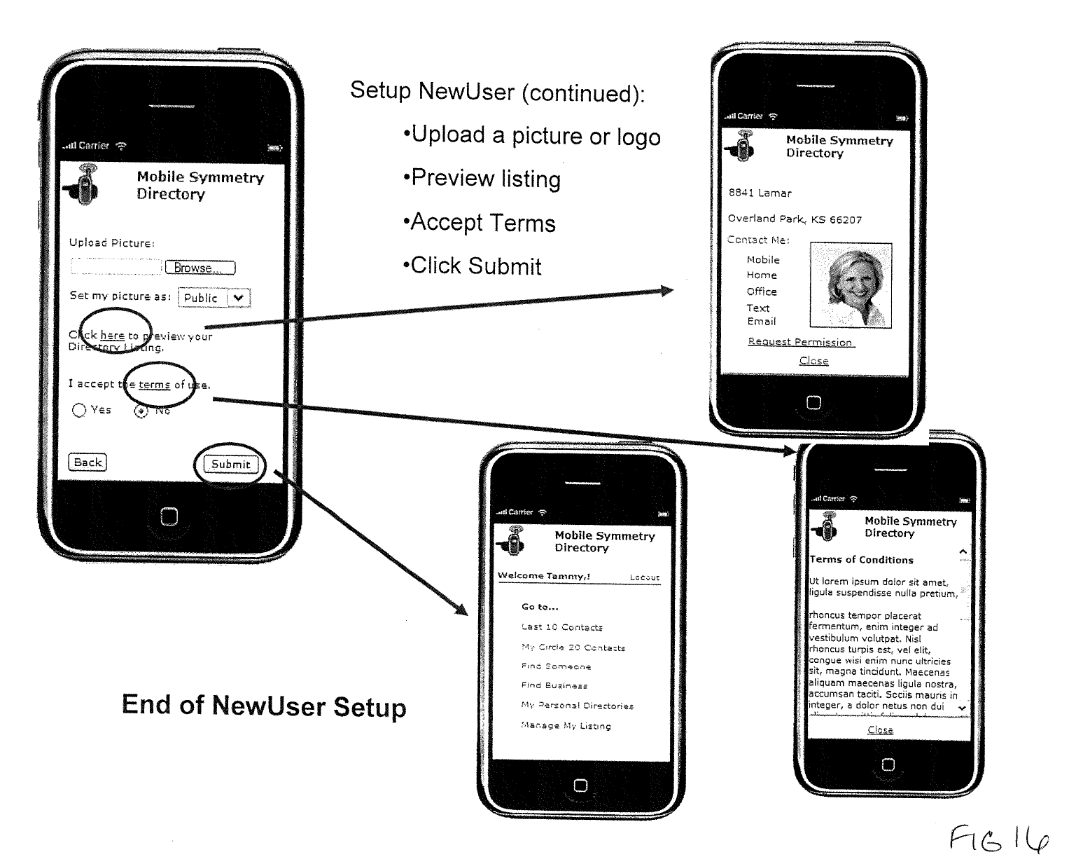

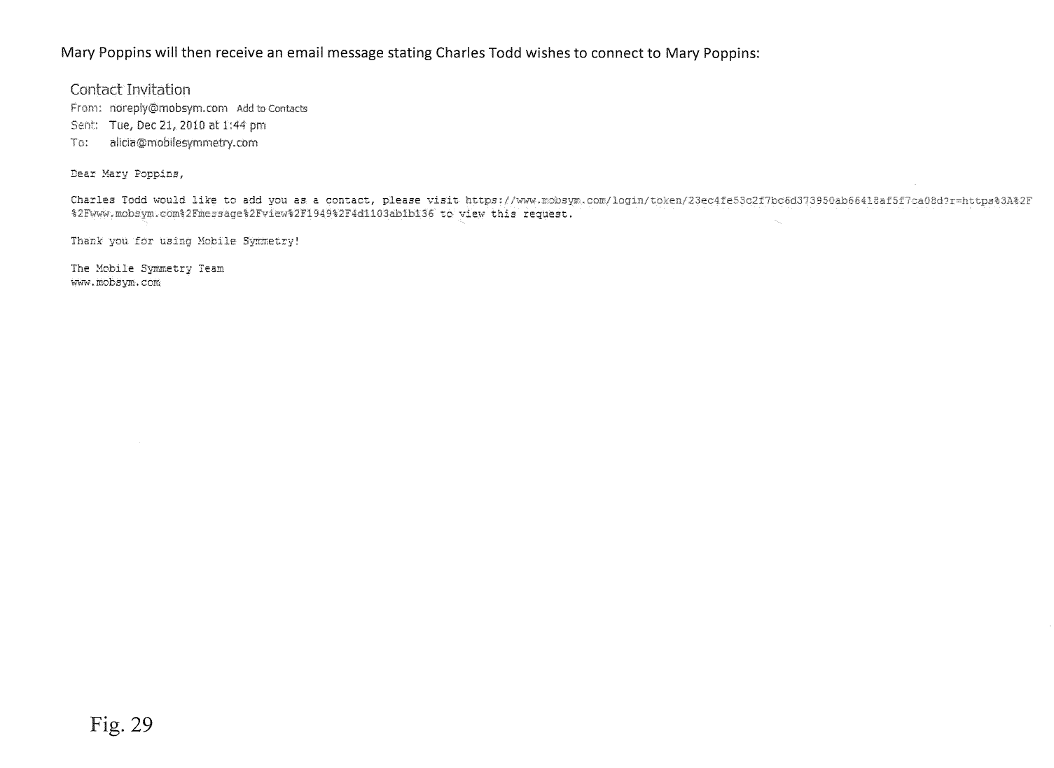

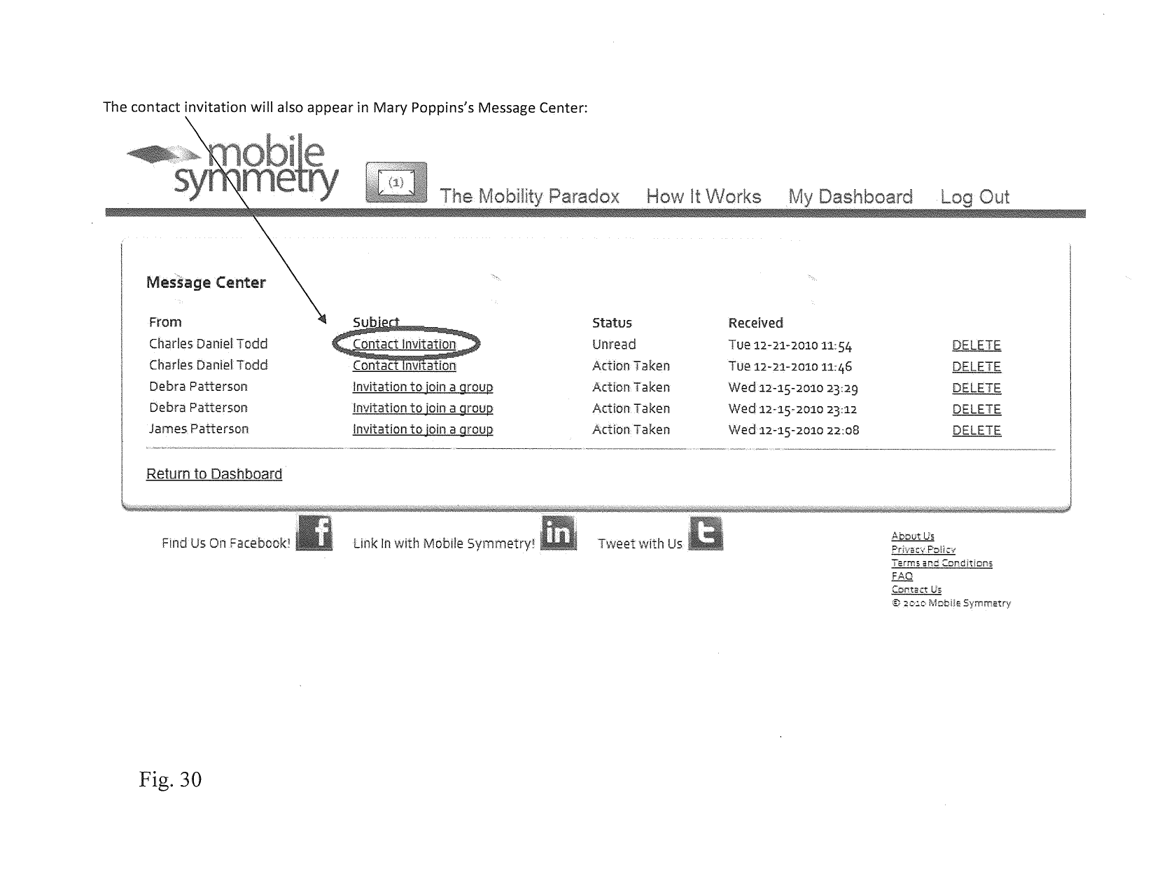

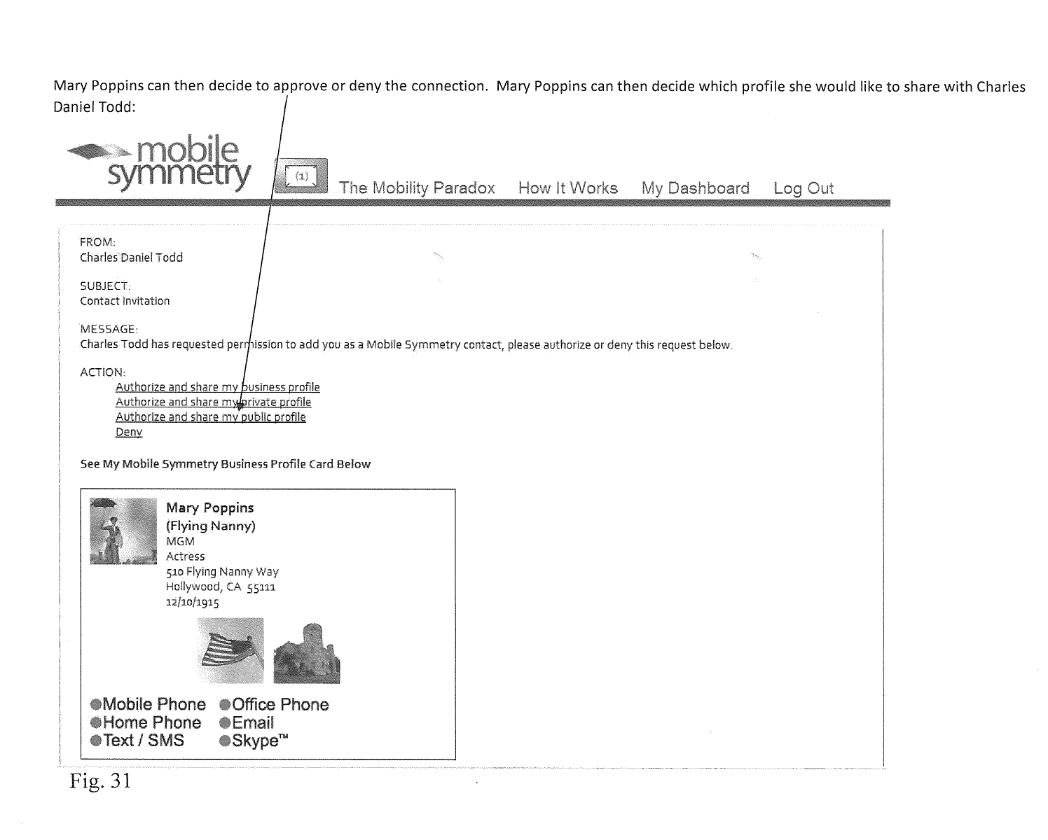

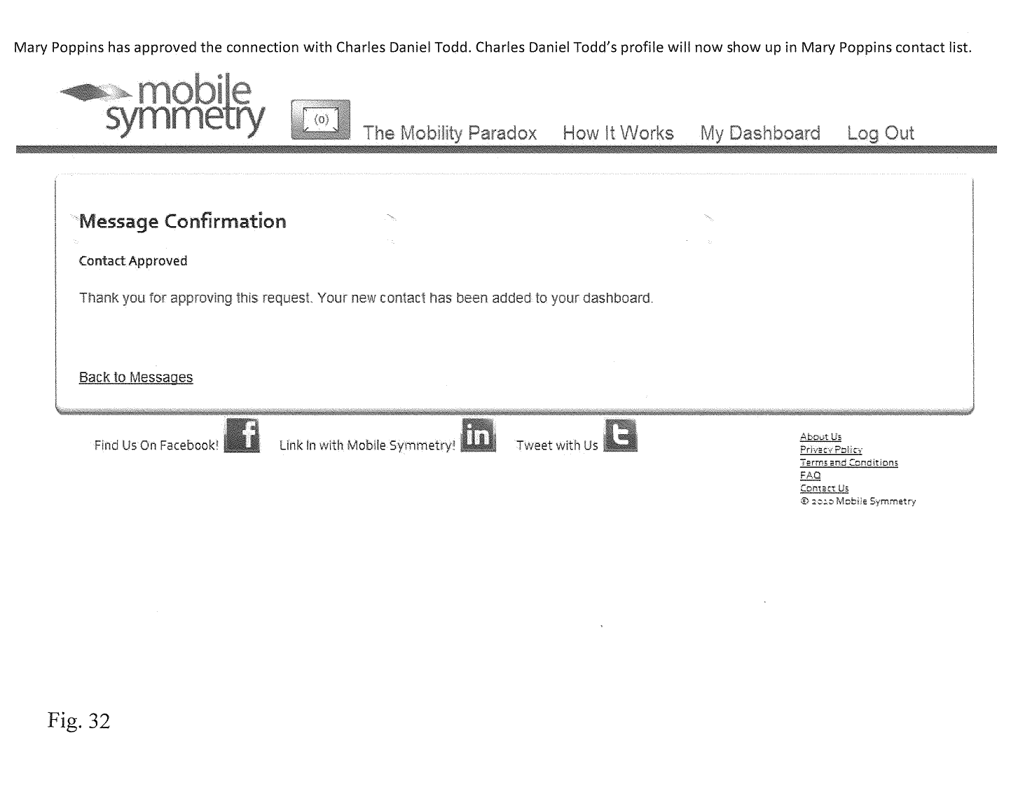

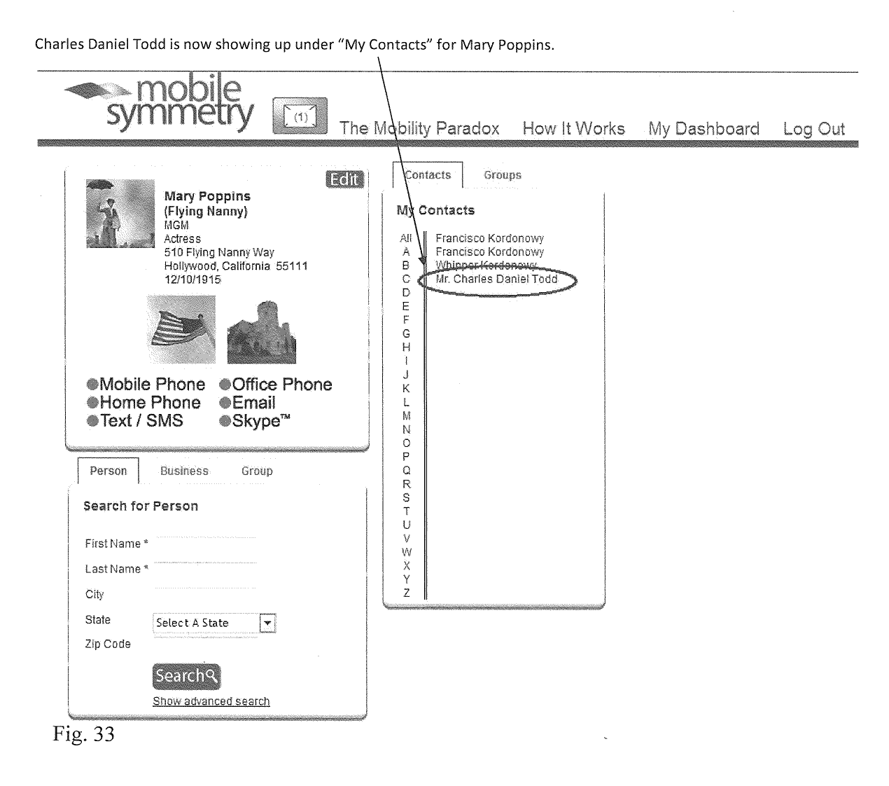

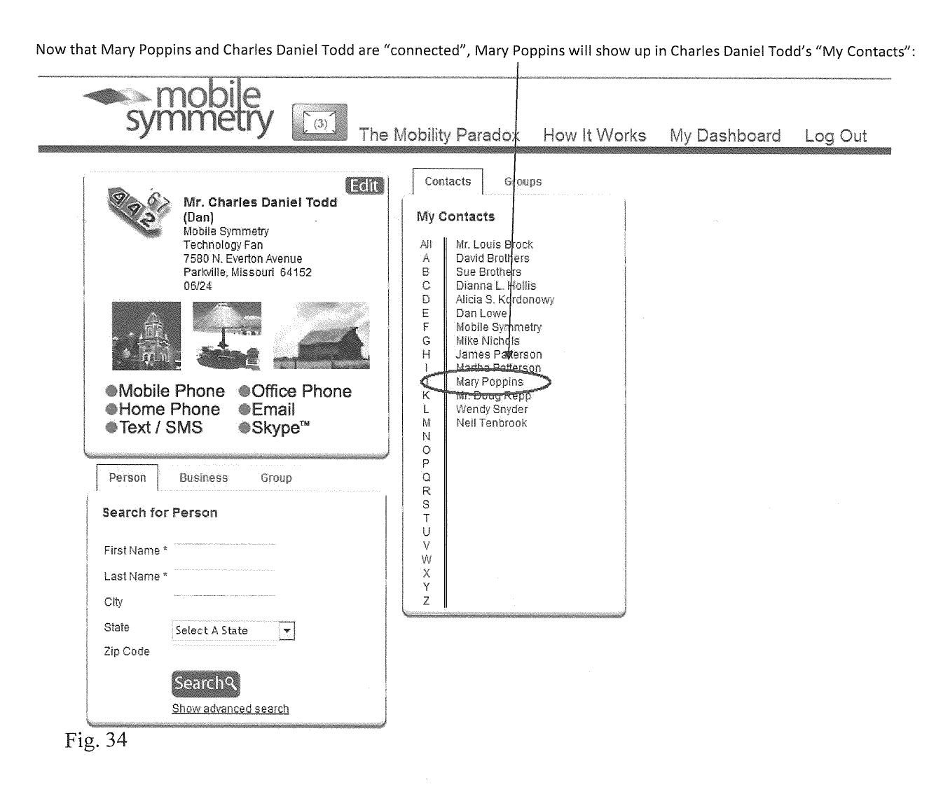

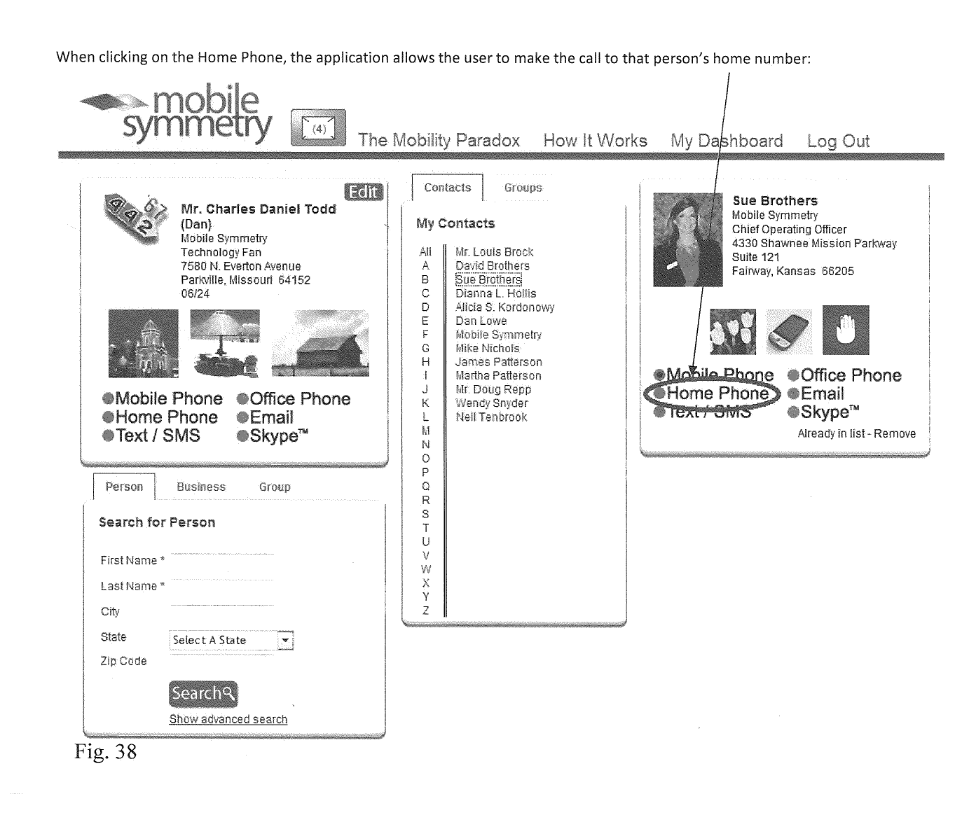

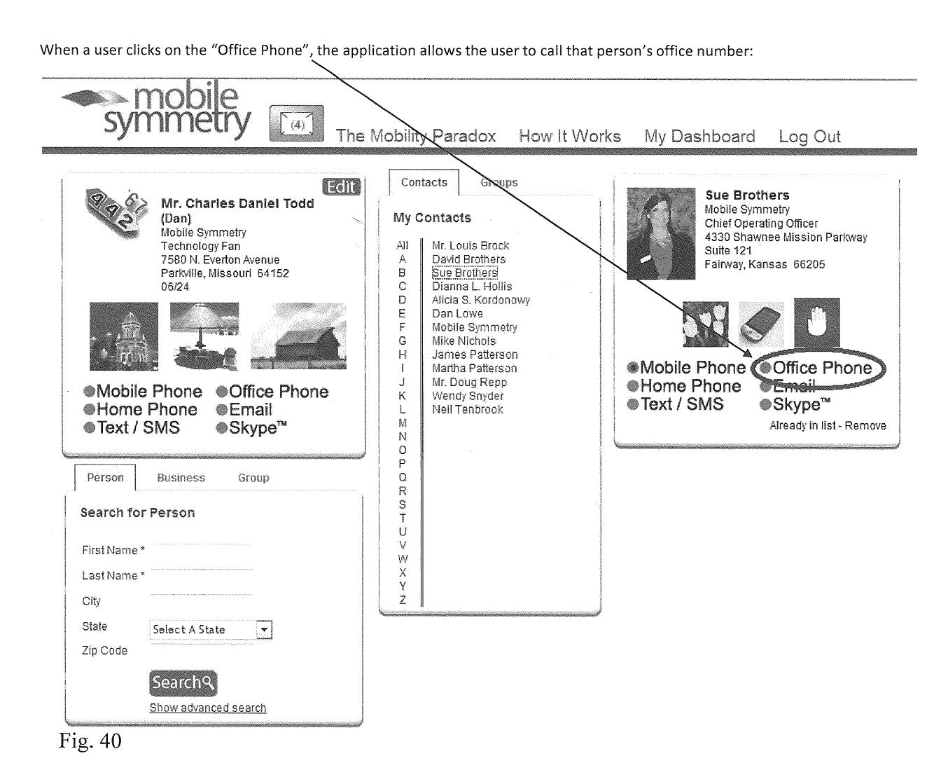

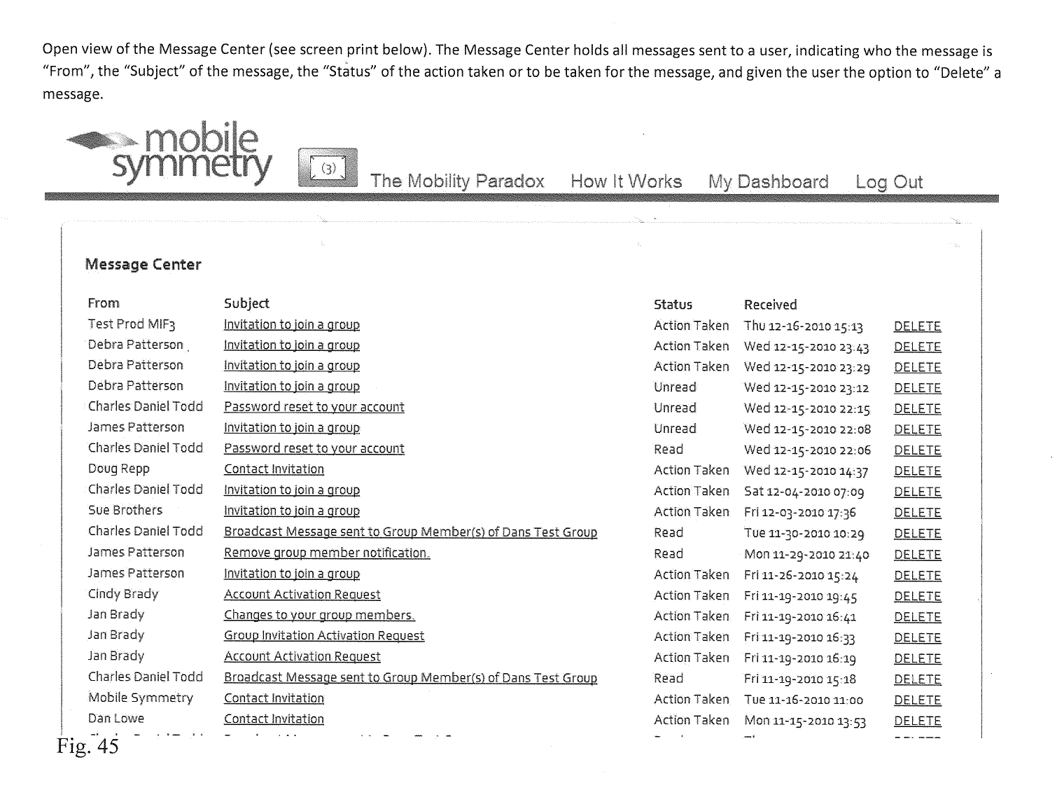

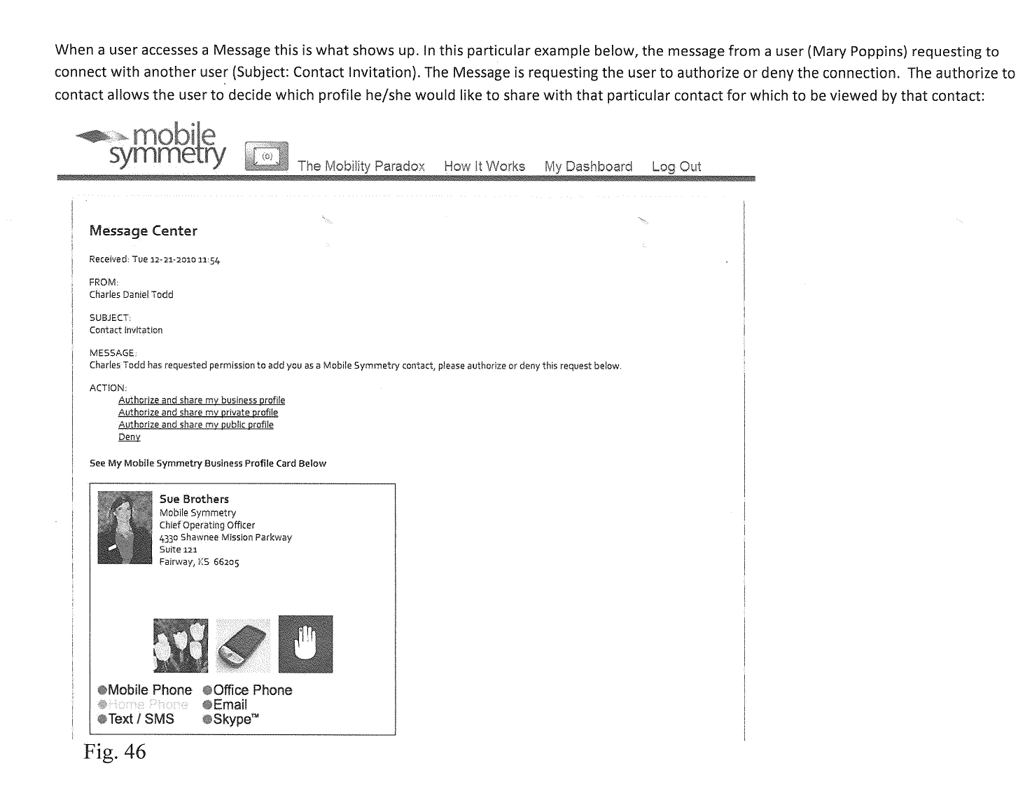

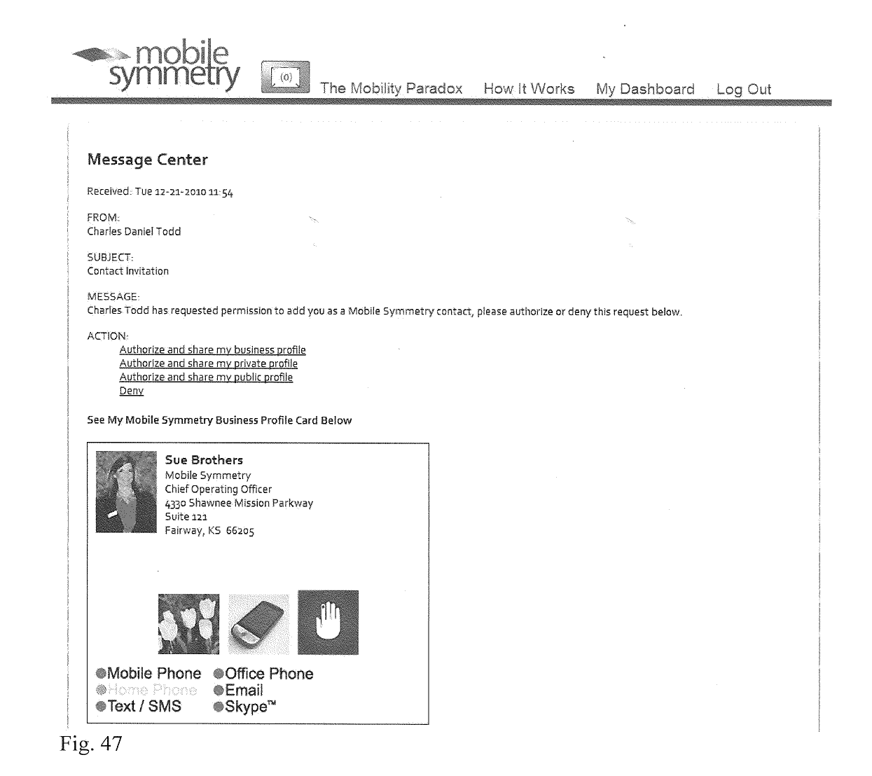

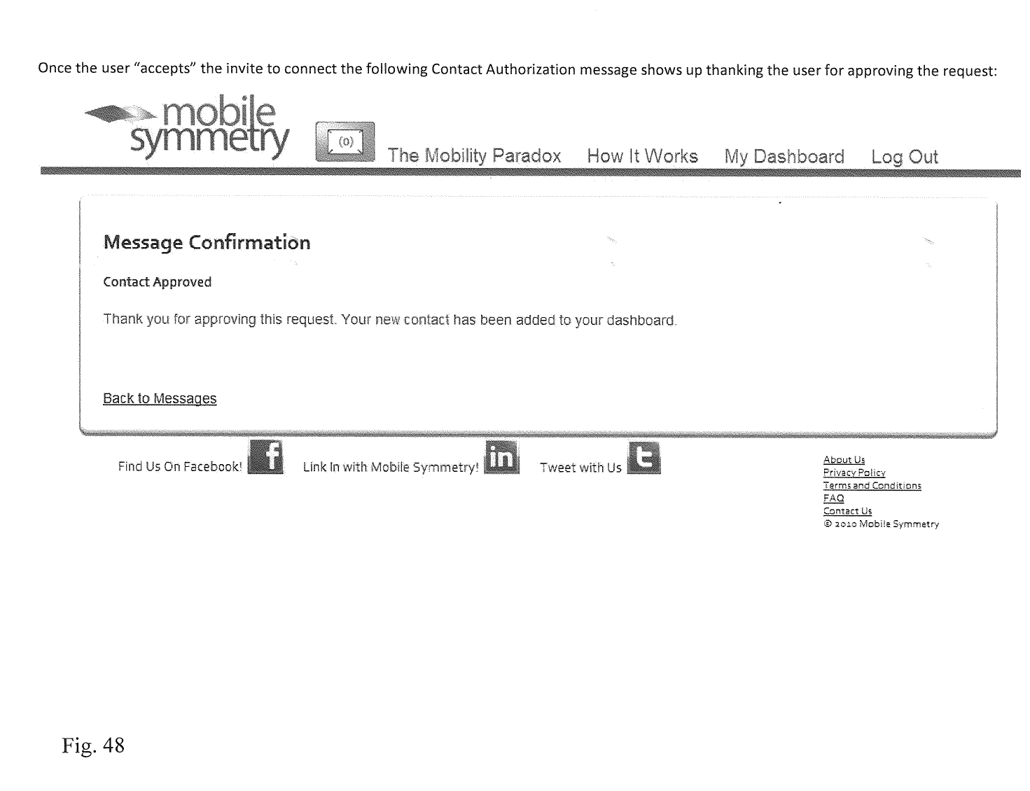

The flow charts of FIGS. 2-6 and the screen shots of FIGS. 7-48 show the functionality and operation of implementations of the invention in more detail. In this regard, some of the blocks of the flow charts and portions of the screen shots may represent exemplary steps in methods of the present invention and/or a module segment or portion of code of computer programs of the present invention. The module segments or code segments of the computer programs comprise one or more executable instructions for implementing the specified logical function or functions. In some alternative implementations, the functions noted in the various blocks may occur out of the order depicted in FIGS. 2-6. For example, two blocks shown in succession may in fact be executed substantially concurrently, or the blocks may sometimes be executed in the reverse order depending upon the functionality involved.

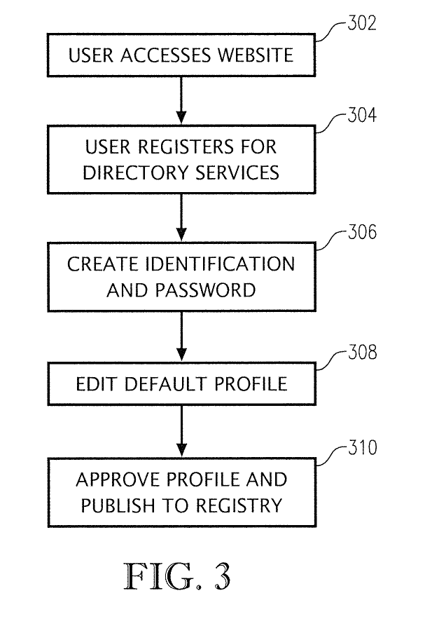

Use of the invention generally begins in one of several ways: (1) when a user of a mobile communication device registers for the directory service features of the present invention while subscribing to, renewing, or upgrading a wireless calling plan with a wireless carrier as generally depicted in FIGS. 2a and 2b; (2) when a user elects to register for the directory service features of the present invention without carrier involvement as depicted in FIG. 3; or (3) when a user is invited by a group directory or other indirect channel.

Referring initially to FIG. 2a, a mobile communication device user may subscribe to a wireless calling plan of any wireless carrier in a conventional manner as shown in step 202. This may be done while purchasing or otherwise obtaining one of the mobile communication devices or 16 when switching an existing mobile communication device to a new mobile calling plan.

A representative of the wireless carrier may then describe the directory service features of the present invention and ask the user if he or she wants to register for these services as depicted in step 204. Information about the directory services may also be conveyed to the user in any other conventional way such as with a website, informational pamphlet, etc. If the user does not want to register to use the directory services, the method ends at step 206.

If, however, the user elects to register for the directory services, the carrier sends information about the user to the registry 12 as depicted in step 208. The information may be the same information that was gathered for the mobile calling plan or some subset thereof. In one embodiment, the carrier only sends the user's name and e-mail address to the registry 12.

The registry 12 receives the information and determines whether the user has already signed up for the directory services in step 210. This may happen, for example, when a user has already registered for the directory services on a previous mobile communication device but then purchases a new mobile communication device and/or subscribes to a new wireless calling plan.

If the user has already registered for the directory services, the registry 12 only stores updated information for the user in step 212. The registry then sends the user an e-mail, text, or other communication in step 214 that welcomes the user and provides instructions for provisioning the user's mobile communication device.

If the user is a new user, the registry 12 stores the user's information in step 216, assigns the user a temporary password in step 218, and then sends the user an e-mail, text, or other communication in step 220 that welcomes the user and provides instructions for provisioning the user's mobile communication device.

Referring now to FIG. 2b, the user receives the e-mail from the registry and is prompted to click on a secured link that connects the user's mobile communication device to the registry or another computing device associated with the registry as depicted in step 222. The user is then prompted to sign-up or register in step 224 and to download a client software application to his or her mobile communication device in step 226. Alternatively, the client software application may be pre-loaded on the user's mobile communication device at the time of purchase or the invention may be used without a client software application.

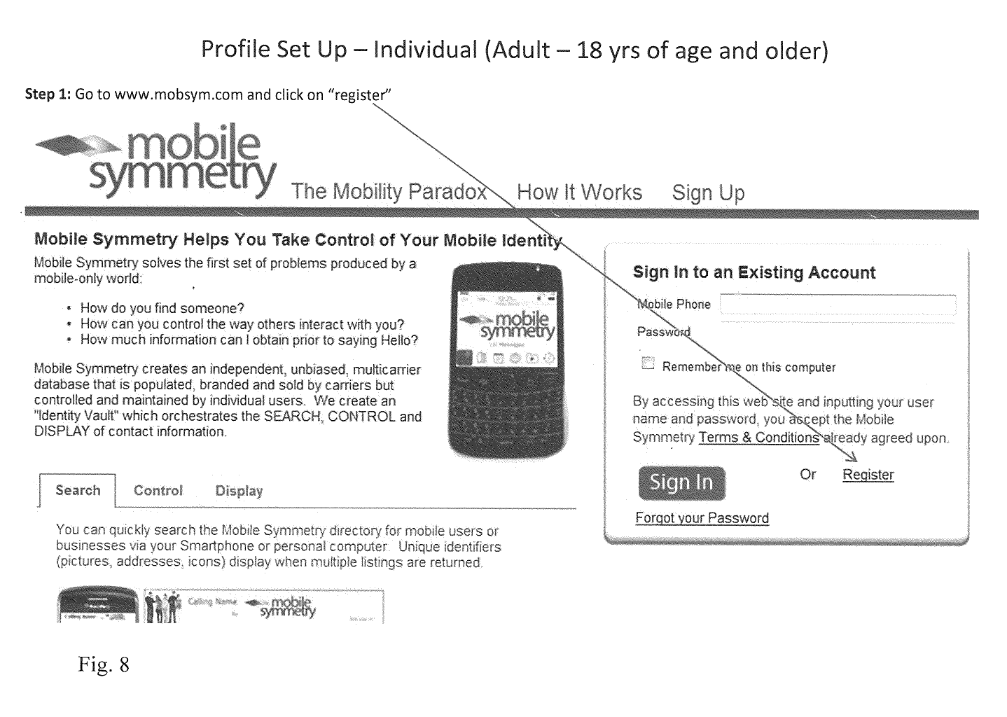

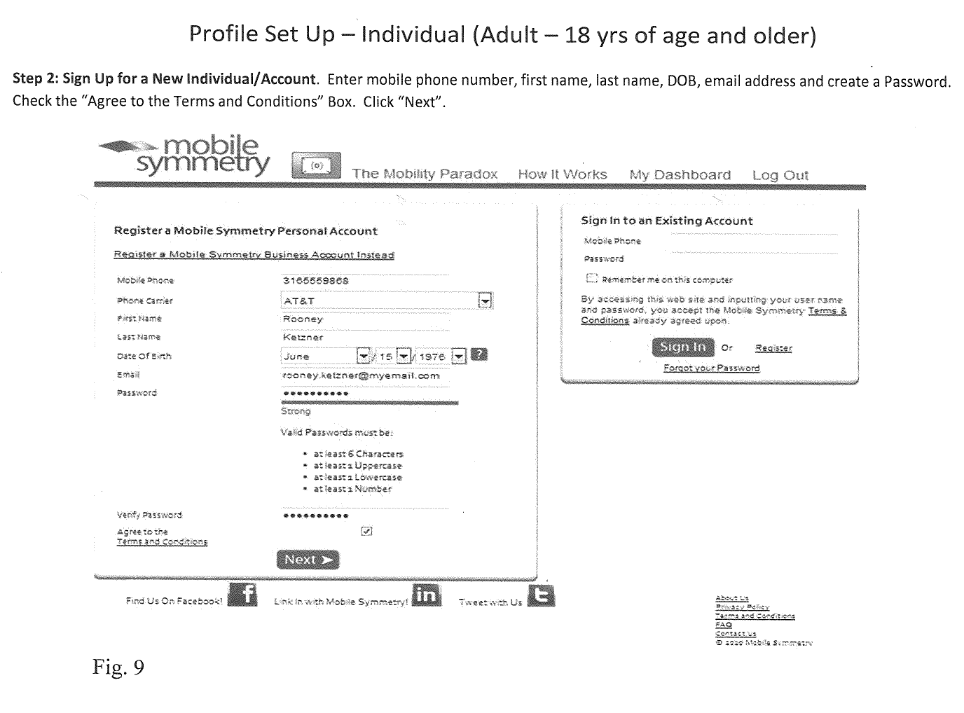

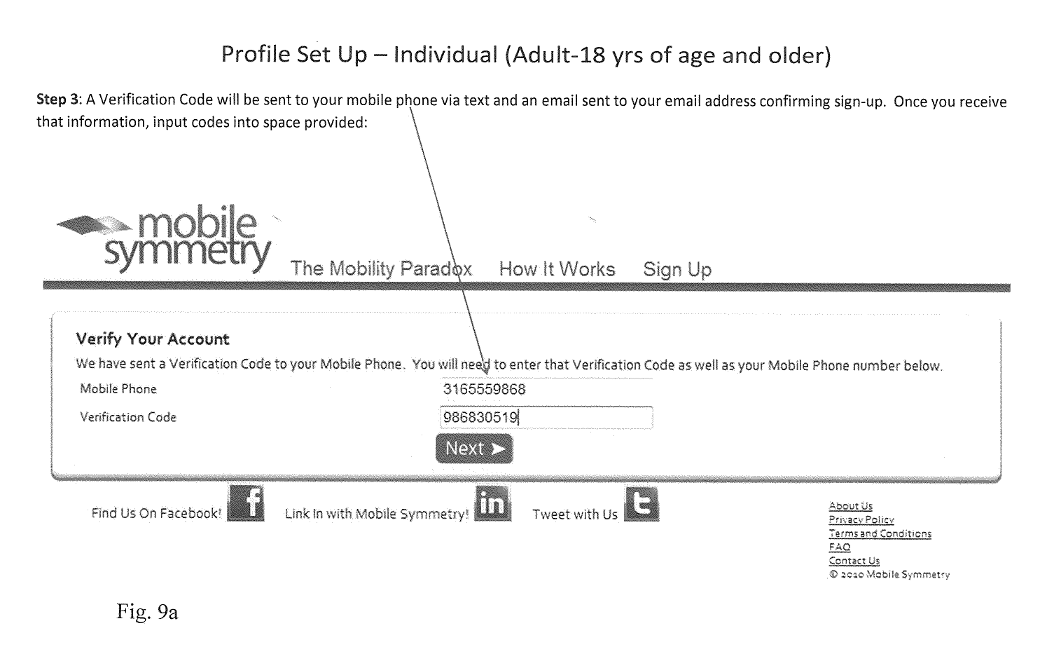

The screen shot of FIG. 7 shows an exemplary icon for the client software application as it may appear on a mobile communication device 16. Similar information may be presented if the user accesses a WAP site without the client software application. To initiate the application, the user clicks on the New Co icon and is then presented with a screen similar to the one shown in FIG. 8. If the user clicks on “Register,” a Profile Set-Up screen similar to the one in FIG. 9 is displayed.

FIG. 9 shows a Profile Set-up screen formatted for a web browser and computer. A similar screen may be provided for access by a mobile communication device. The screen of FIG. 9 prompts a new user to enter his or her mobile phone number, phone carrier, first name, last name, date of birth, and e-mail address and instructs the user to create a password as a new user. The screen of FIG. 9 also allows the user to select whether a Personal User profile or Business User profile is to be created. The user must then click on “Agree to the Terms and Conditions.” A verification code is then sent to the user's mobile phone via text and an e-mail is sent confirming the sign-up as shown in FIG. 9a. Once the text or e-mail is received, the user inputs the verification code into the space provided and clicks “Next.”

The user may then begin creating his or her user profile as depicted in step 228. In some embodiments, the user's user profile is pre-populated with basic customer information gathered by the wireless carrier or a third party group so the user only has to supplement and/or edit the information. In one embodiment, each user's user profile may include three customizable profile views: public, private, and business. The public view contains information that anyone with a profile in the registry may access. The private view contains information that can only be accessed by users who have obtained the user profile owner's permission. The business view may be private as well and requires the same permission approval as the private view. User profile owners must allow other users to “opt in” to the private and business views as described in more detail below; only the public view is available to all profile users.

Importantly, the registry of user profiles and all other features of the present invention are fully compliant with the Children's Online Privacy Protection Act (COPPA) and similar pending proposals for minors (children are under 13 years of age, minors are between 13-18). All child and minor profile information is protected starting with the initial requests for information from the child/minor, through the gathering of the information, and to the storing and access of the information. For example, a child is only allowed to have a private view, whereas a minor may have a public view and a private view. For a child profile, one or more responsible adults must be designated, and the responsible adult(s) must approve the child's profile before it is posted, all views of the profile, which directories the child opts into, and any changes to the profile. Similar protections are provided for minor profiles, except with a minor profile, the responsible adult(s) may approve the initial profile and then may elect to either approve all profile changes and directory access or just be notified of the same.

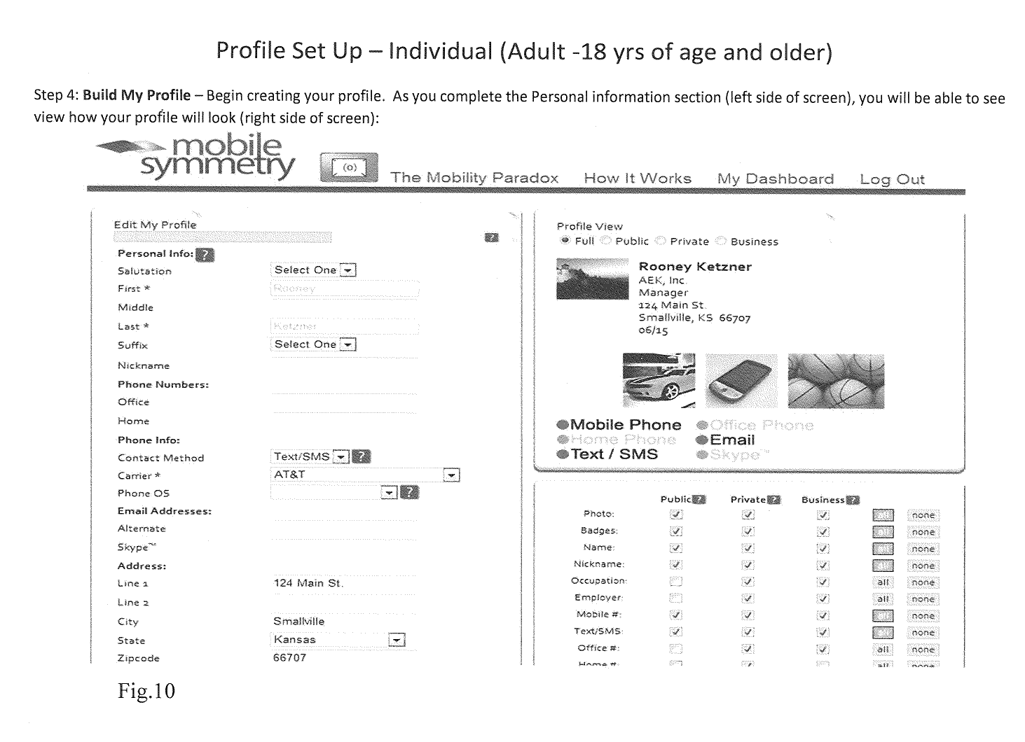

The screen shots of FIGS. 10-22a show details of certain steps a user may perform to create or edit an individual or personal profile. These screen shots are examples only and may be replaced with and/or supplemented with other screen shots without departing from the scope of the invention. The screen shots are for an individual or Personal Profile—similar screens not shown may be used to create or edit business profiles.

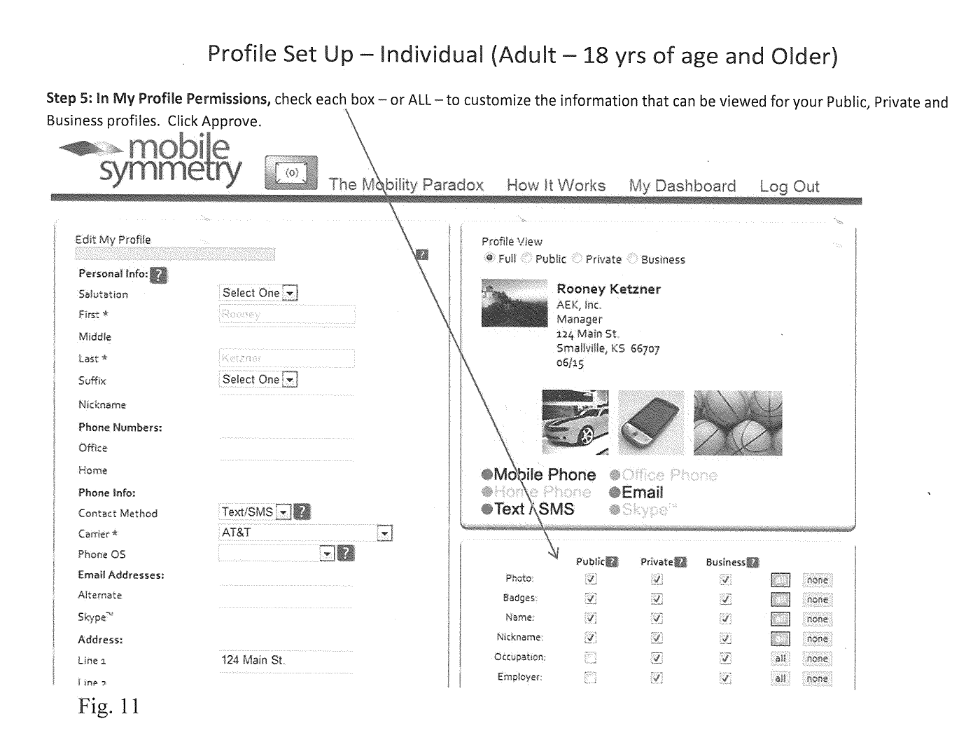

FIGS. 10 and 11, which together show a single screen that may be scrolled, prompt the user to build a profile by entering personal information, contact information, and profile permission elections. The user may also provide a photo, a badge, and other identifying information. For each piece of information entered or otherwise submitted, the user may designate it for a public view, private view, or business view by selecting the appropriate permission selection box.

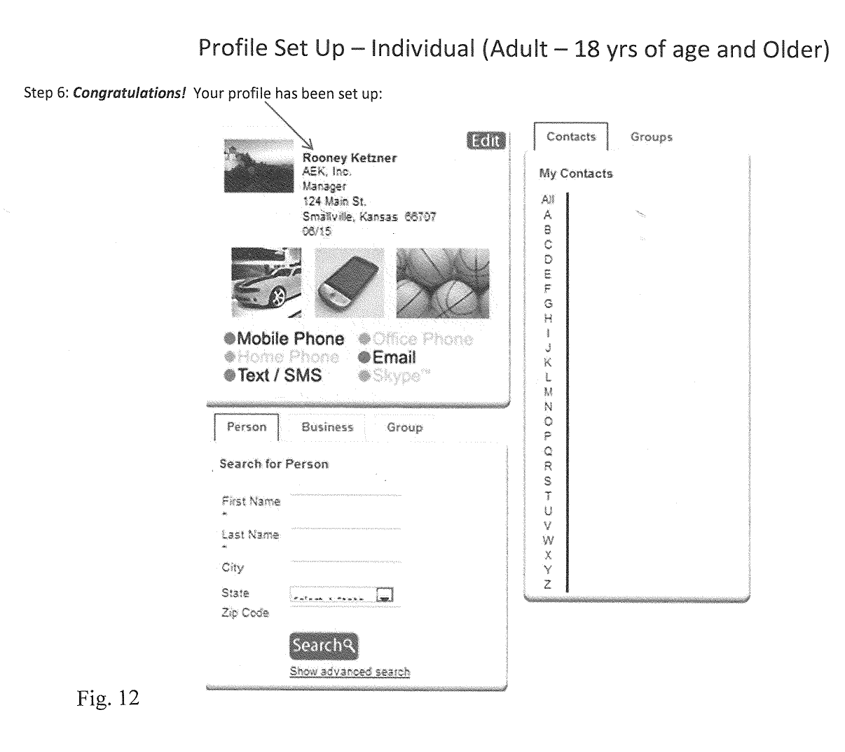

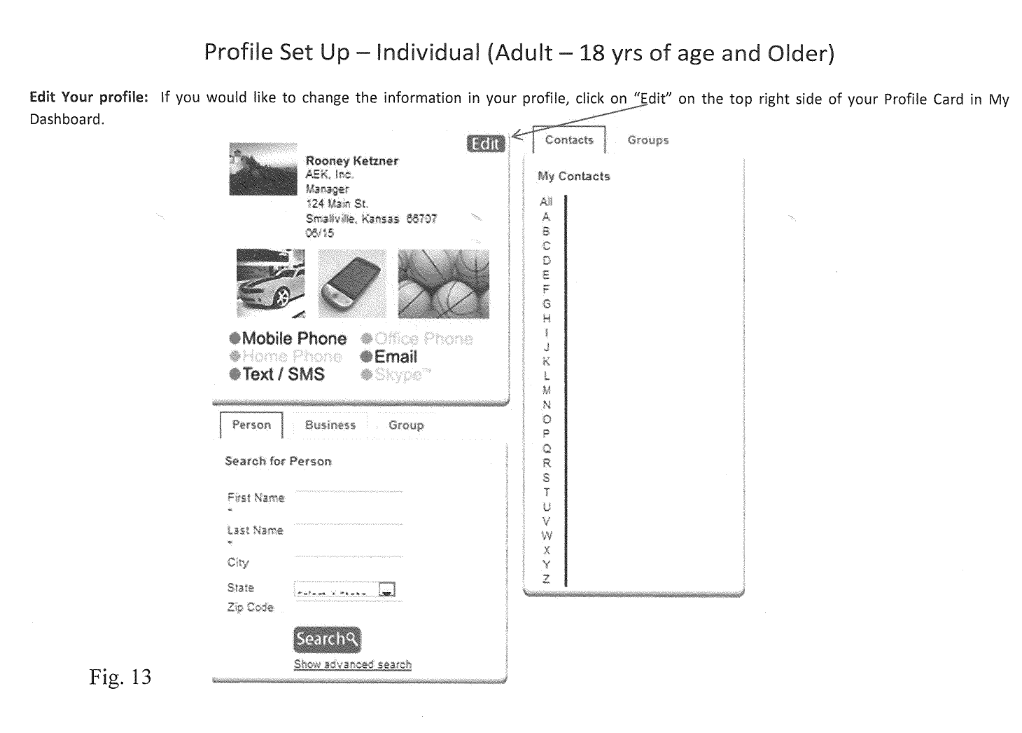

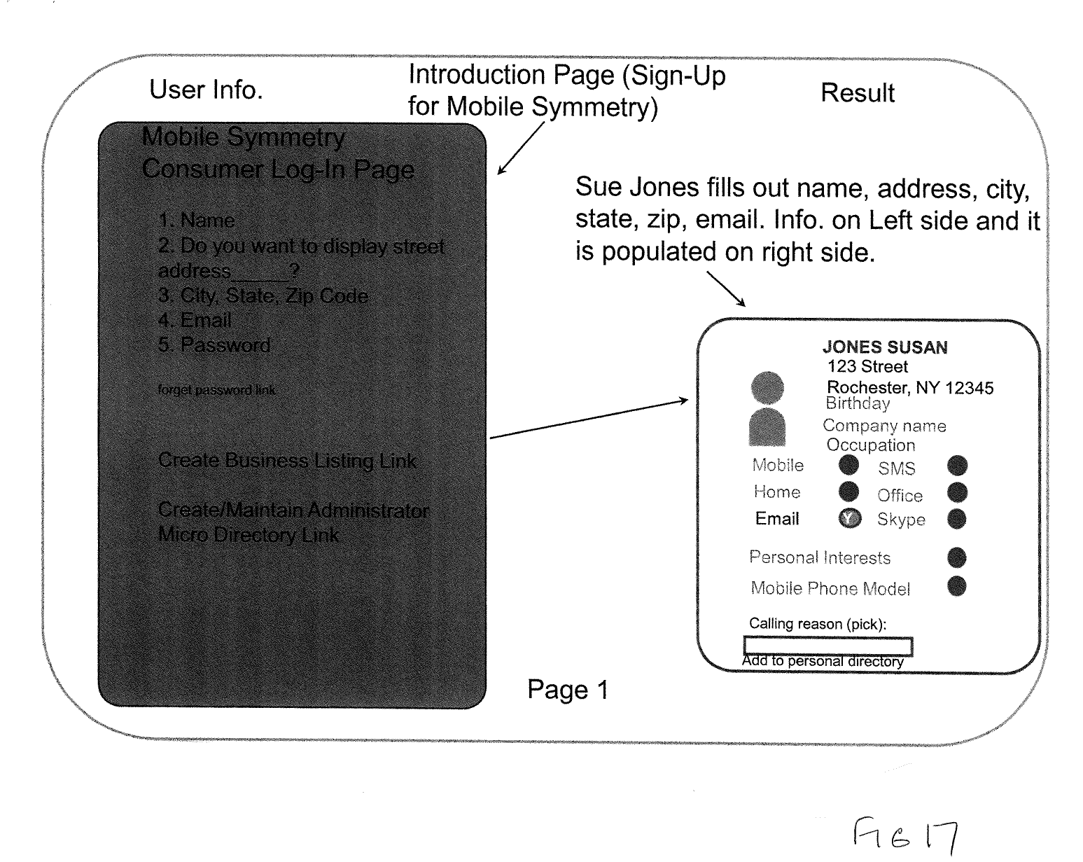

After the user has completed inputting their profile information shown in FIGS. 10 and 11, he or she may click on a Next or Approve button and be presented with the screen shot of FIG. 12, which displays the user's profile. The user may choose to edit and/or update the profile as shown in FIGS. 13-15. FIG. 16 shows a screen formatted for a mobile communication device that permits a user to preview their profile.

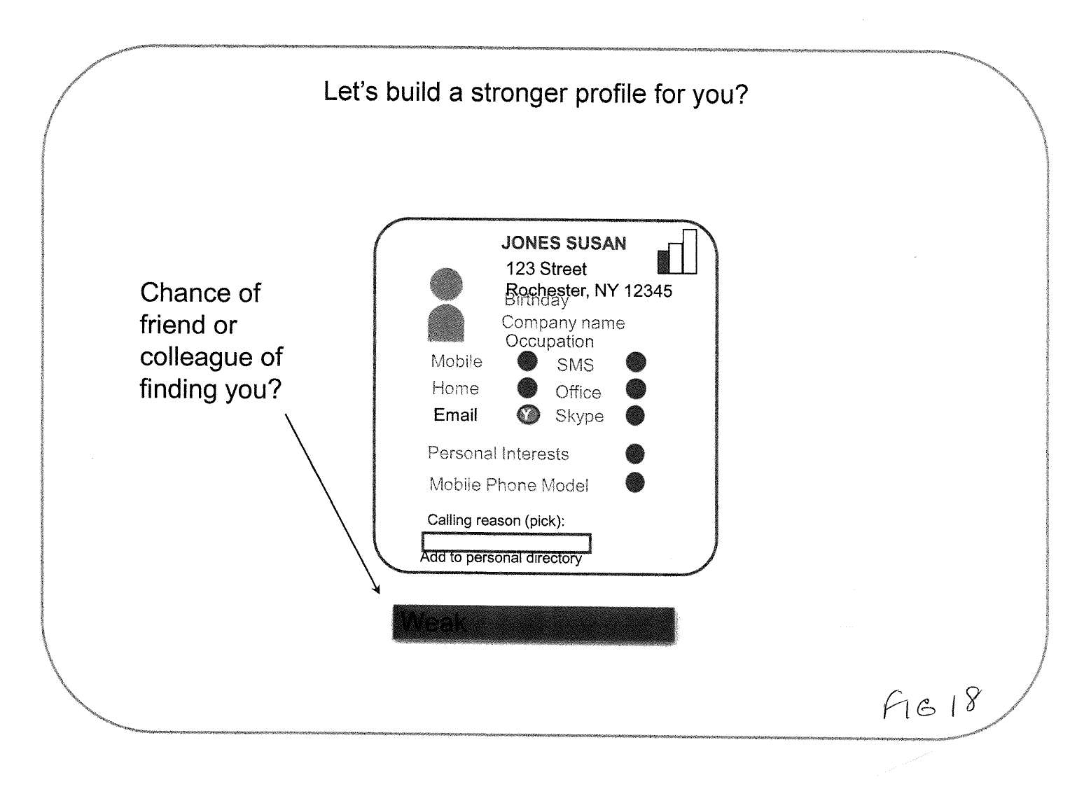

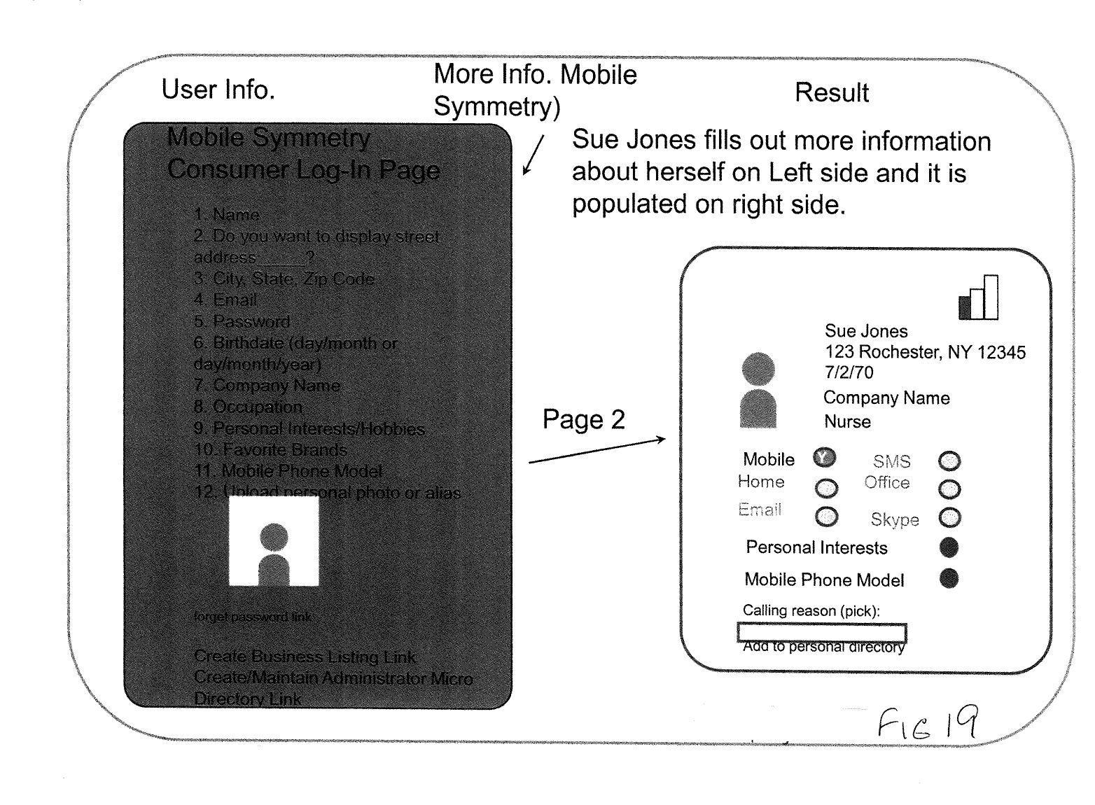

The more information a user adds to his or her user profile, the more likely other are to locate the user's user profile in the registry. For example, if the user has a common name and only lists his or her name and basic contact information in the user profile, others searching for the user may receive numerous “hits” when searching for the user, whereas if the user lists his or her occupation, place of work, schools attended, etc., searchers will likely find the user quickly. The present invention therefore incorporates a user profile-grading feature that assesses the strength, or findability, of a user profile, and then encourages a user to add more information to his or her user profile to strengthen it. For example, FIGS. 17 and 18 show a user profile for a user who only enters her name, street address, city, state, zip code, and e-mail address. As shown in FIG. 18, the user profile-grading feature of the present invention determines that this is a weak user profile and encourages the user to build a stronger profile.

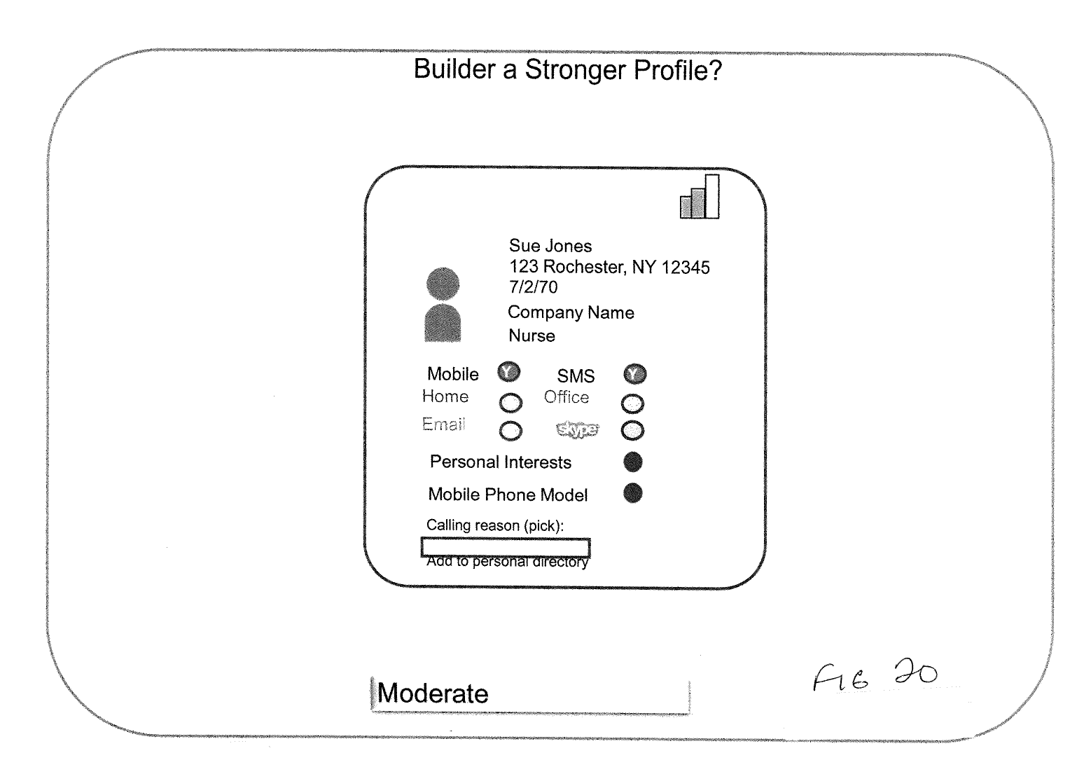

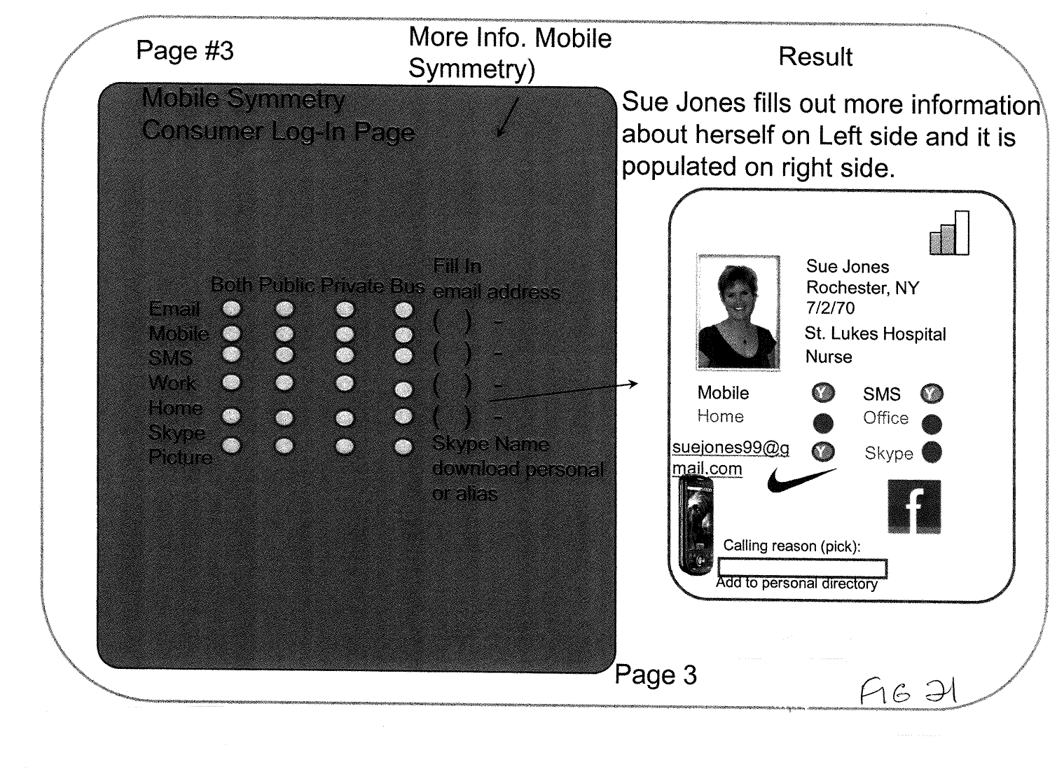

FIGS. 19 and 20 show a user profile for a user who enters additional information along with her name, street address, city, state, zip code, and e-mail address. As shown in FIG. 20, the user profile-grading feature determines that this is a moderately strong user profile and again encourages the user to build a stronger profile.

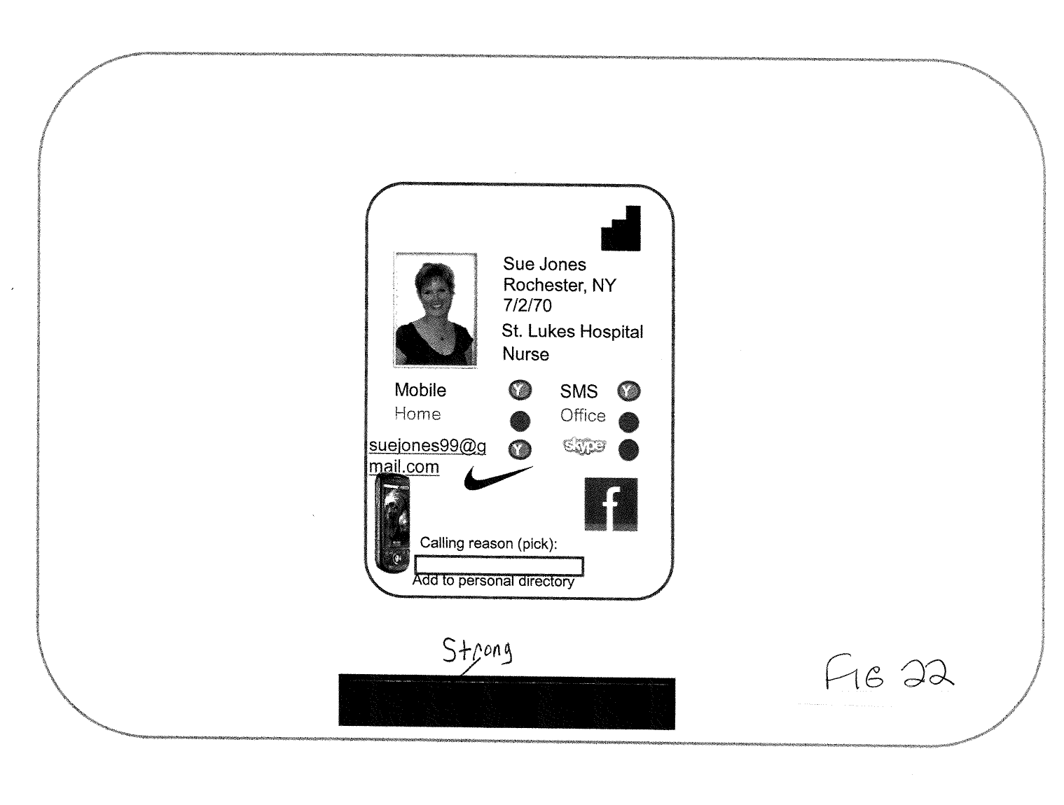

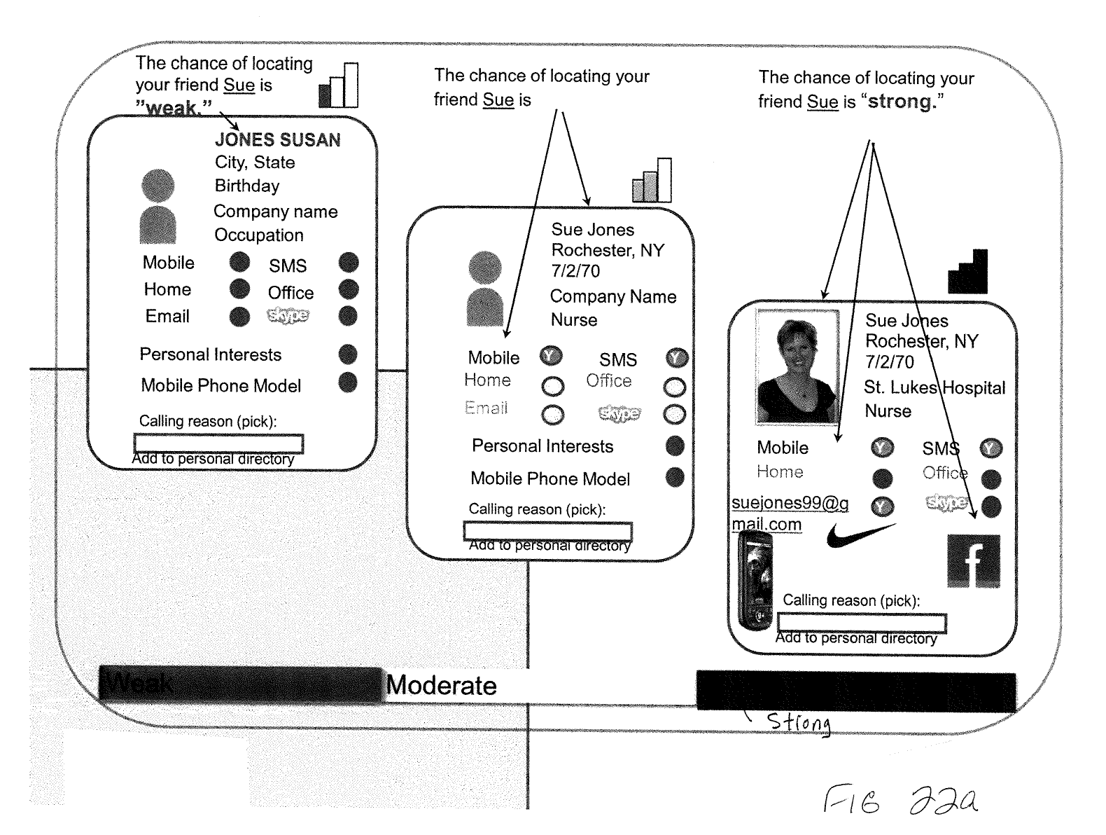

FIGS. 21 and 22 show an exemplary user profile for a user who enters even more information. As shown in FIG. 22, the user profile-grading feature determines that this is a strong user profile.

FIG. 22a shows a weak user profile, a moderate user profile and has approved it, and a strong user profile for the same user to illustrate the advantages of a stronger user profile. The user profile-grading feature may assess the strength of a user profile by merely gauging how complete the user profile is. For example, user profiles with less than 50% of the available fields populated may be ranked as “weak,” user profiles with 50%-70% of the available fields populated may be ranked as “moderate,” and user profiles with 70+% of available fields populated may be ranked as “strong.” Alternatively, the user profile grading feature may use more sophisticated algorithms for assessing the strength of user profiles.

Once the user has finished creating or updating his or her user profile, the registry publishes the user profile in step 230 so that it may be accessed by others wishing to contact the user as explained in more detail below. The registry also sends a message to the wireless carrier serving the user's mobile communication device so that a trigger may be set in the MSC serving the mobile communication device so it knows the mobile communication device has registered with the registry. No message is sent if the invention is implemented without carrier involvement.

In addition to receiving information for the user profiles directly from the users as described above, the registry 12 may be pre-populated with basic contact information received from wireless carriers 38, the Number Portability Administration Center (NPAC) 36, Telecordia's LERG Routing Guide, and/or other sources as shown in FIG. 1. This information may be used to create default user profiles that may then be customized by users as described above.

Turning now to FIG. 3, exemplary steps are illustrated for how a user may register for the directory services for an existing mobile communication device or wireless calling plan. The user first accesses the registry 12 or a website operated by his or her carrier as depicted in step 302. Information about the directory services features may be conveyed to the user via the registry or website or any other conventional way. The user is then prompted to enter basic registration information as depicted in step 304.

The user then opens the client software application and is prompted to enter a user ID and password in step 306. The user may then create or update his or her user profile in step 308. The profile is created via the website and may be edited via the website or the mobile client application. As mentioned above, the user profile may be pre-populated with basic information gathered in step 304 so that the user only has to supplement and/or edit the default information. The creation and/or editing of the user profile then follows the same steps explained in detail above with respect to FIG. 2 and the related screen shots.

Once the user has finished creating or updating his or her user profile and has approved it, the registry 12 publishes the user profile in step 310 so that it may be accessed by others wishing to contact the user as explained in more detail below. The registry also sends a message to the wireless carrier serving the user's mobile communication device so that the MSC serving the mobile communication device knows the mobile communication device is registered with the registry. No message is sent if the invention is implemented without carrier involvement.

The user may also be invited to join the registry via an indirect channel such as by a group of which the user is a member. In this case, an administrator of the group may send contact information for the user to the registry. The user then receives an e-mail message that invites him or her to join the registry. The user then completes the steps 302-310 described above.

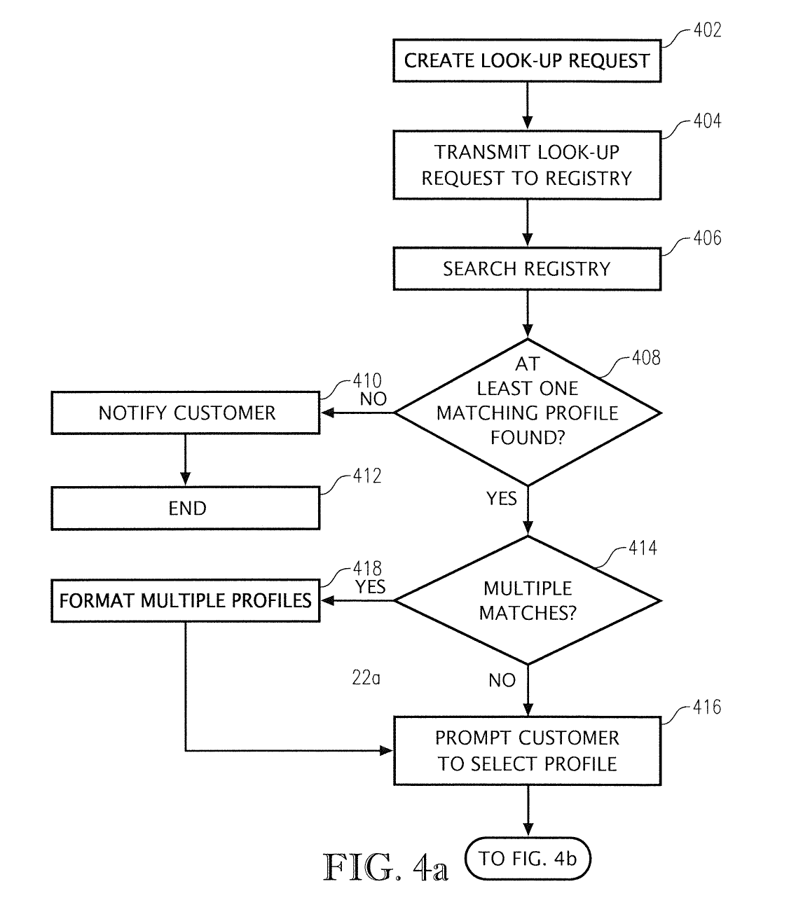

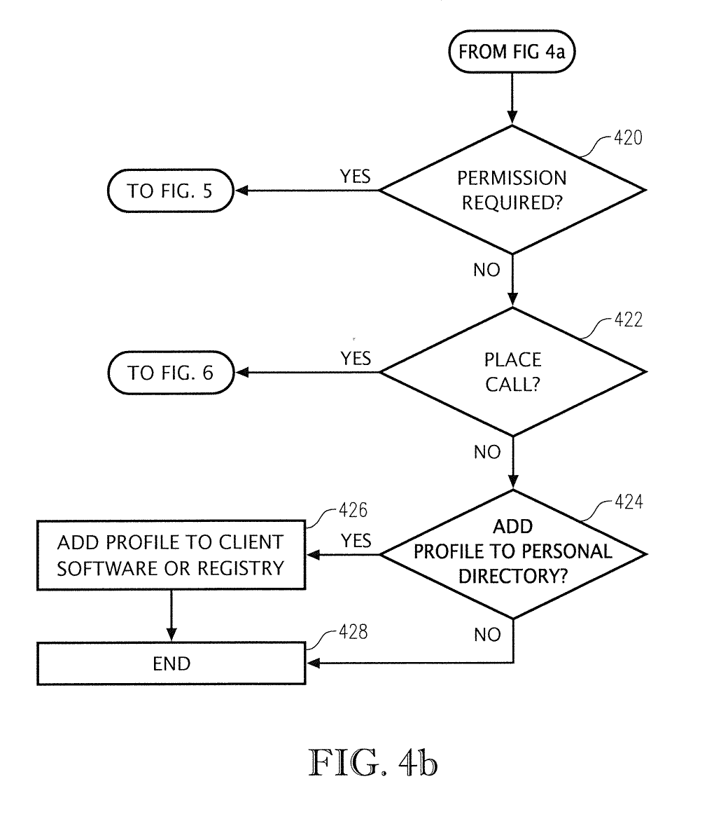

Once the registry 12 has been populated with numerous user profiles as described above, users may begin to search the user profiles to contact other users. FIG. 4 depicts exemplary steps when a user of the mobile communication device 16a wishes to access the registry 12 to locate a user profile for the user of mobile communication device 16b. The user first opens the software application on his or her mobile communication device and selects a “Find Someone” button or icon. The user is then prompted to create a look-up request as depicted in step 402. These steps and the following steps may also be performed without the client software application by accessing the registry via a web browser.

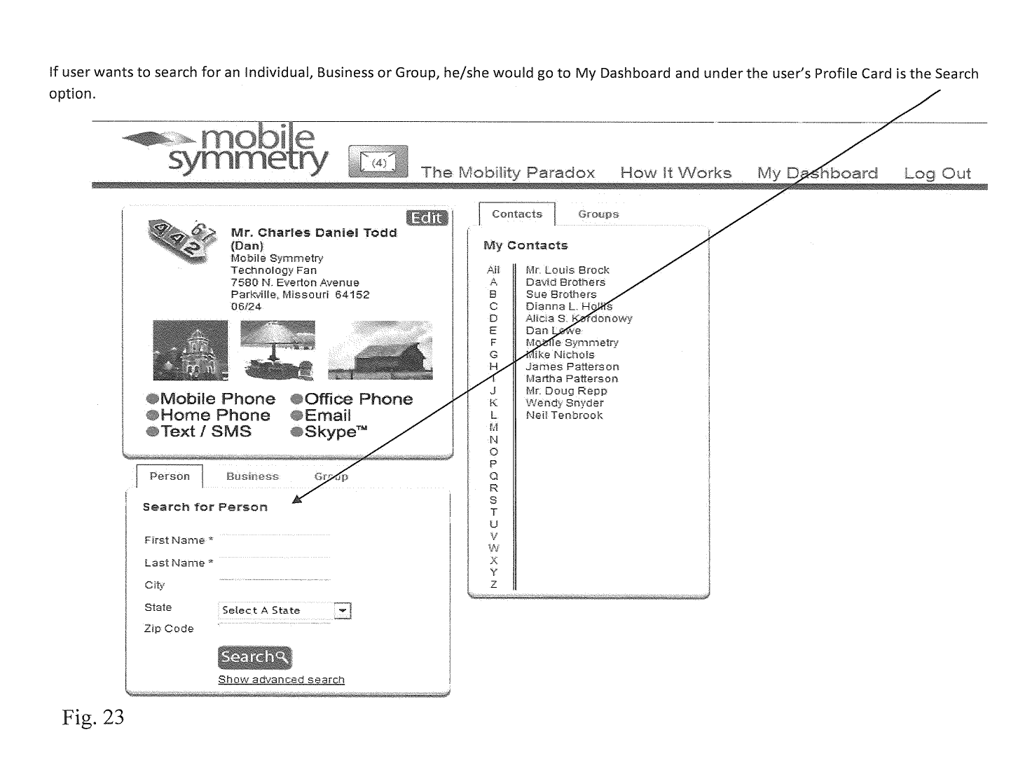

The screen shot of FIG. 23 show an exemplary Find Someone screen that may be used to created a look-up request. The user populates the screen with a person's name and address, and then clicks a “Find” button to transmit the look-up request to the registry 12 as depicted in step 404 of FIG. 4.

The registry 12 searches the user profiles in response to the look-up request in step 406 and attempts to find a user profile that matches the look-up request. The registry may use conventional searching algorithms and methods for this step.

Step 408 then determines if at least one matching user profile was found in the registry. If not, the method proceeds to step 410 where the user is notified that no user profiles match the information in his or her look-up request and the method ends at step 412. However, if at least one matching user profile was found in step 408, the method proceeds to step 414 to determine if more than one match was found. If only one matching user profile was found, the method proceeds to step 416, but if multiple user profiles were found, the method proceeds to step 418.

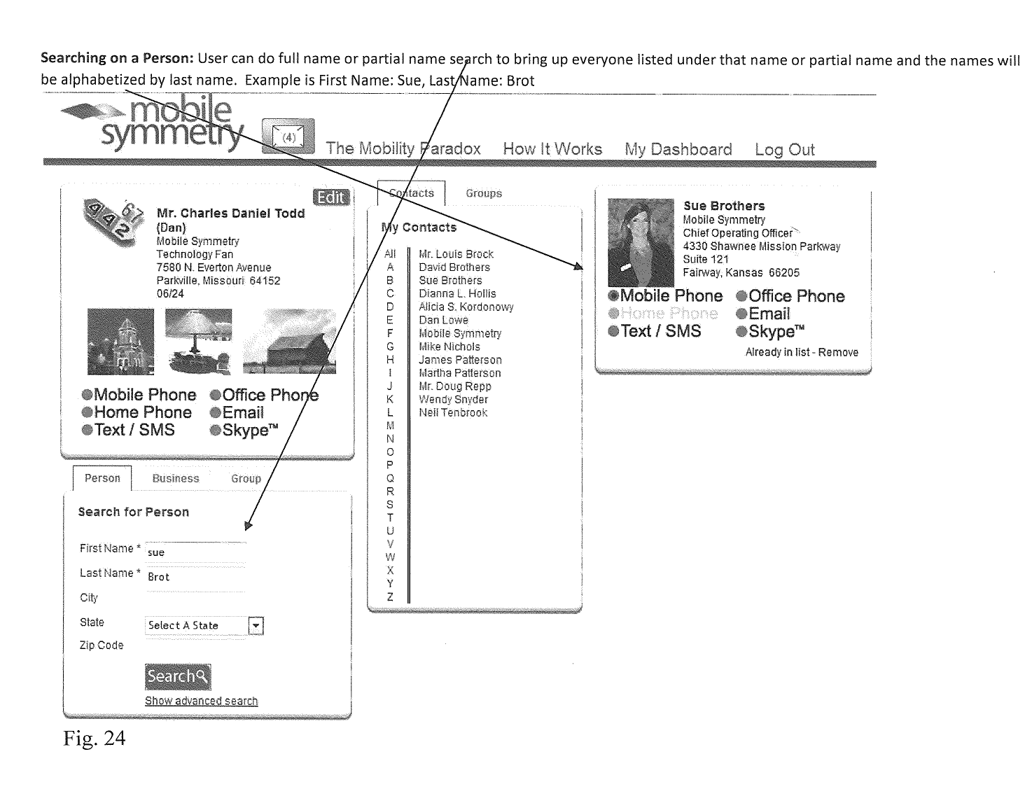

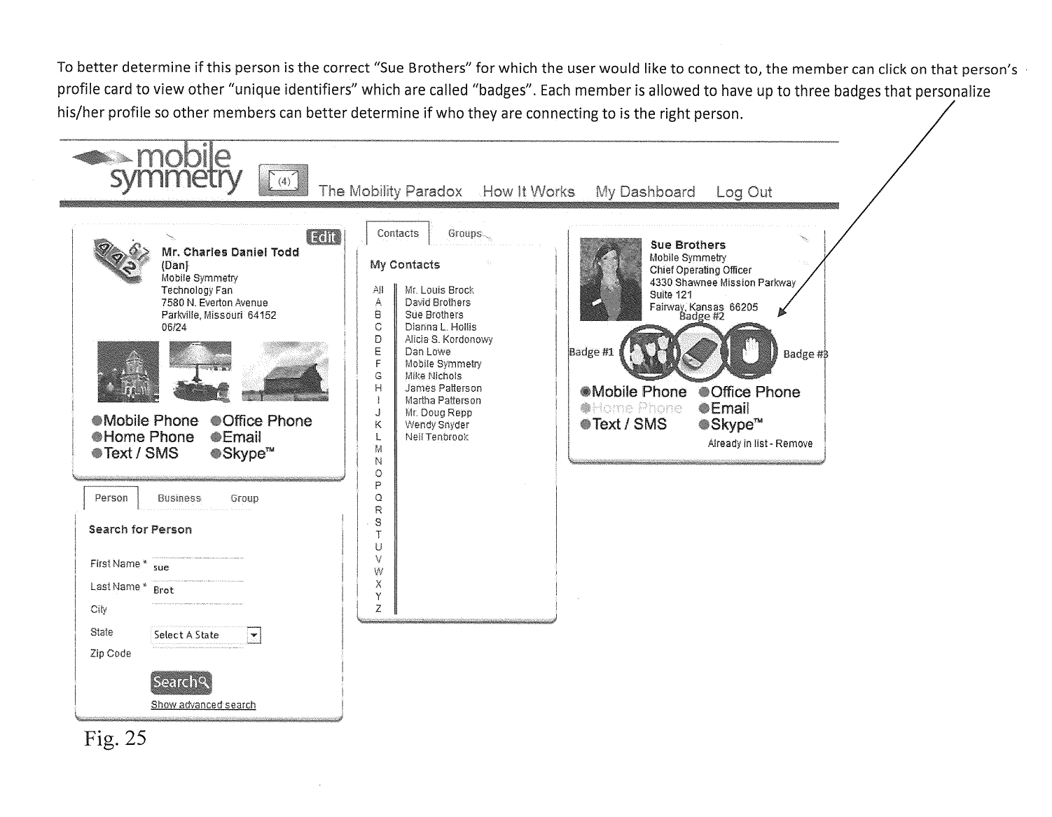

FIGS. 24 and 25 illustrate exemplary screen displays for a look-up request that results in a single matched user profile. A look-up request for “James Patterson” is shown in FIG. 24. The registry 12 receives the look-up request, searches the user profiles, finds a single matching user profile for “James Patterson,” and sends the user profile or a portion thereof to the user's mobile communication device. The user may then click on a button or link to any of James Patterson's permitted contact methods to contact the user profile owner.

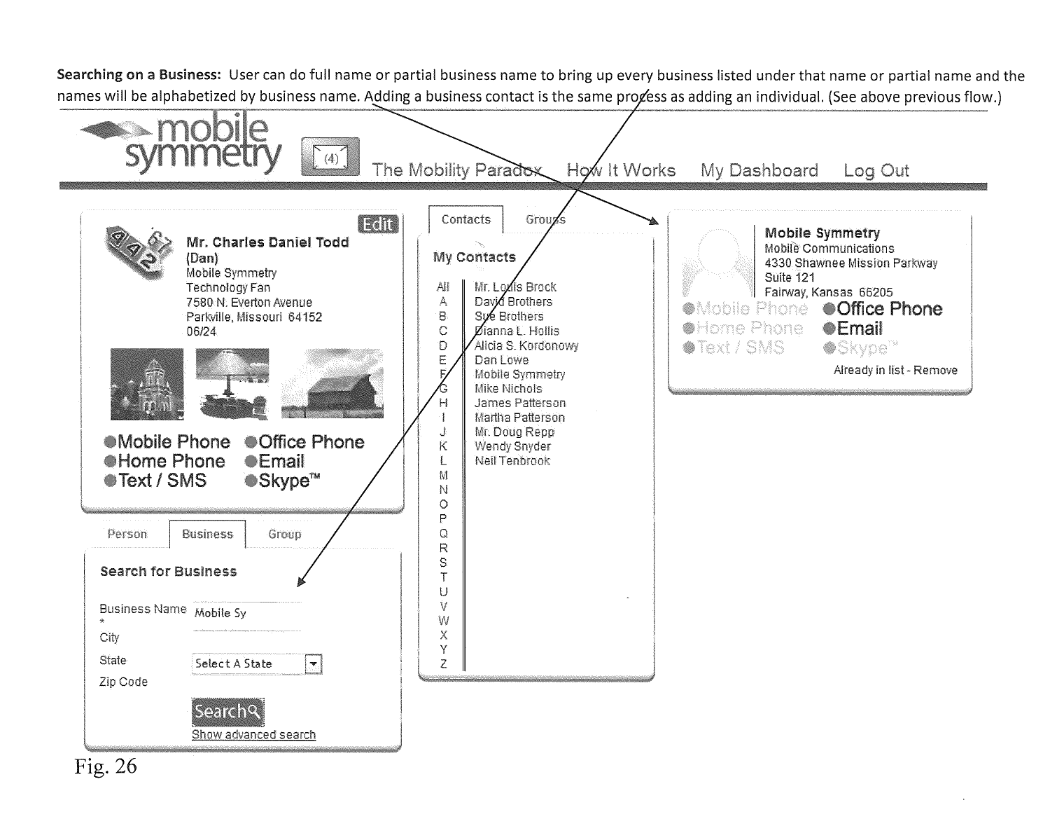

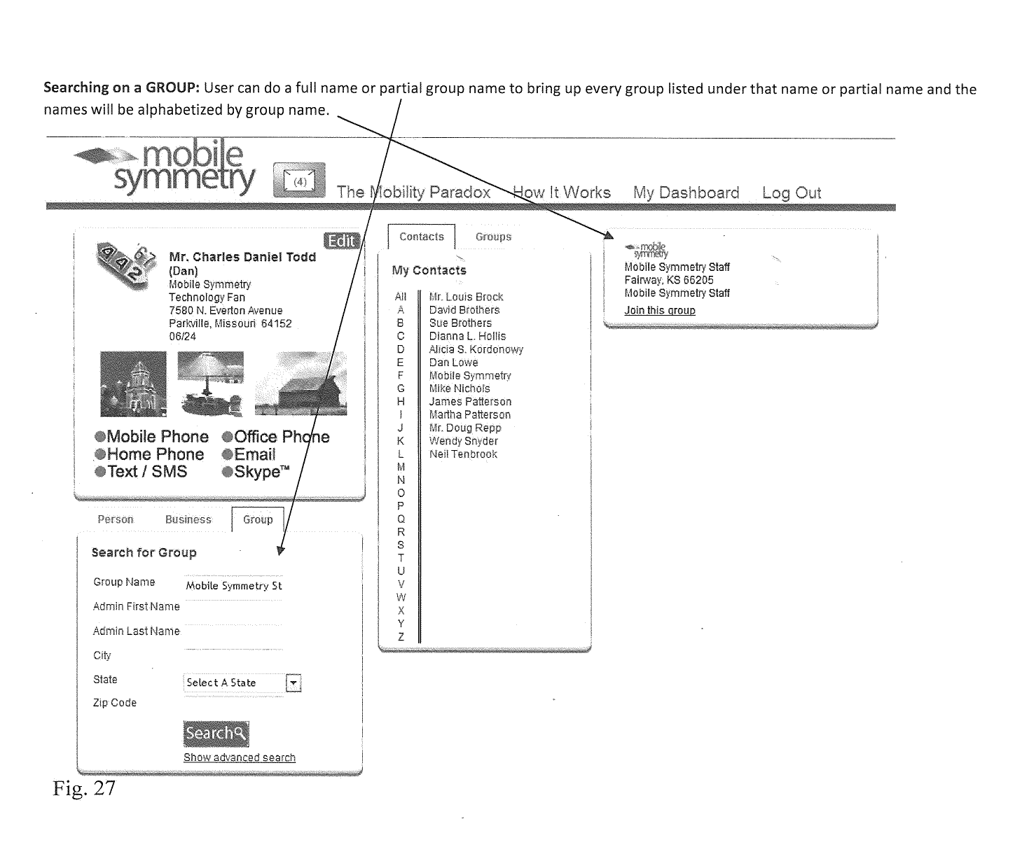

FIGS. 26 and 27 show similar screens for searching for a business or group.

The registry may also determine that the requestor and the user profile owner have the same wireless carrier. If so, the registry indicates on the user profile that any wireless calls to the user profile owner are “in-network.” When called, the user profile owner receives a similar “in-network” notification.

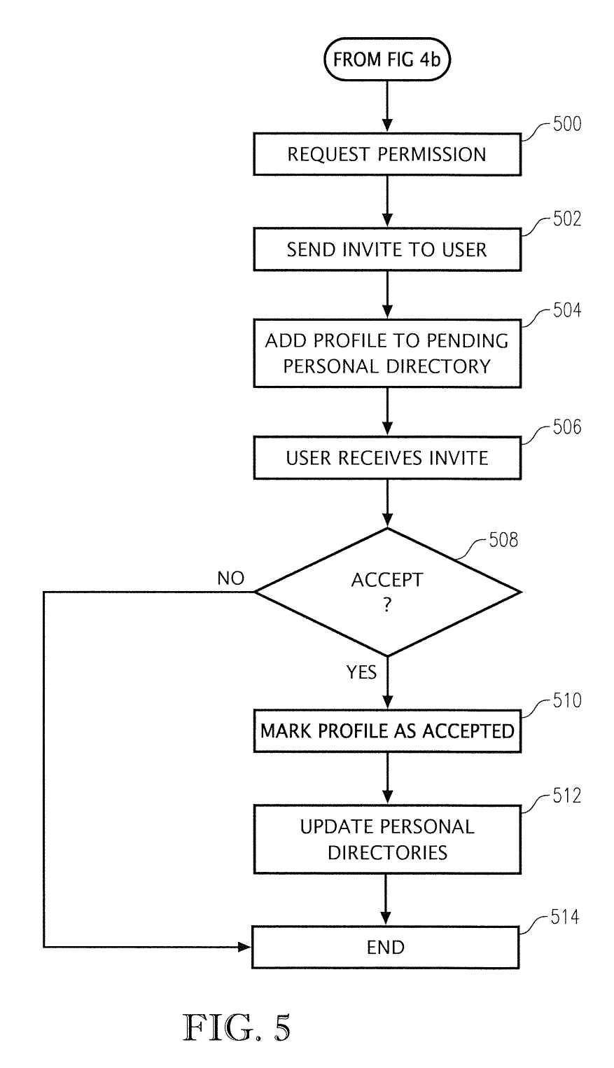

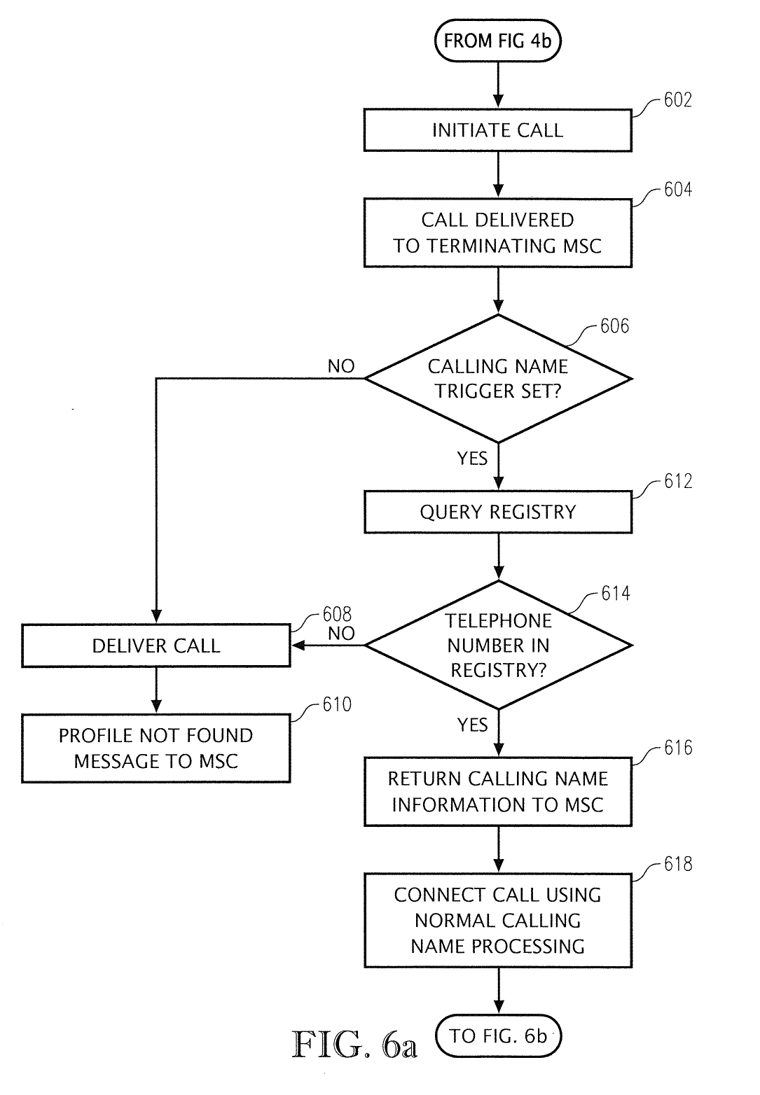

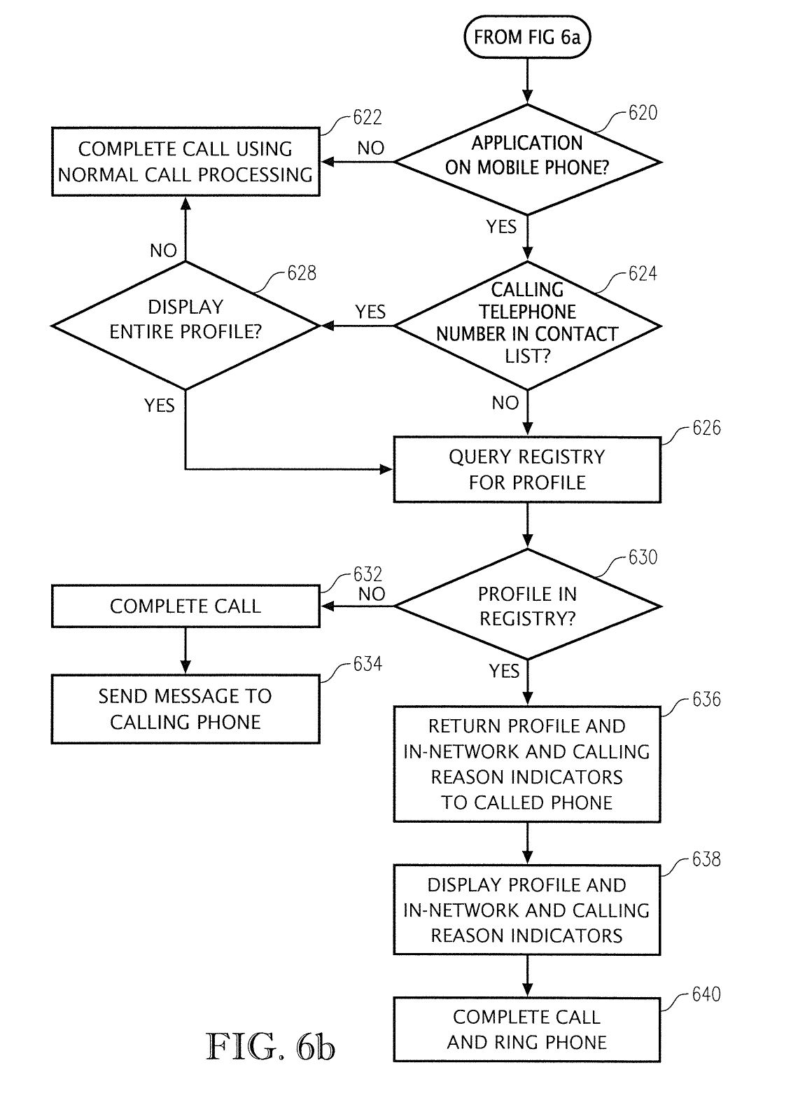

Referring now to FIG. 4b, once the user has found a user profile and wishes to contact the owner of the user profile, the method determines whether permission is required in step 420. As explained above, each user may control who may contact him or her by setting permission controls in his or her user profile. If permission is required, the method proceeds to FIG. 5, which is discussed in more detail below. If permission is not required, the user may elect to contact the user profile owner in step 422, in which case the method proceeds to FIG. 6, which is also discussed in more detail below.

If the user does not want to contact the owner of the user profile yet, the user may instead elect to add the user profile to a personal directory in steps 424 and 426. The client software application on each user's mobile communication device allows the user to create and maintain a personal directory for frequent contacts. Unlike conventional contact lists, however, the personal directory only stores the names of the contacts on the mobile communication device and not phone numbers, addresses, etc. Instead, the names in the personal directory are linked to the user profiles stored in the registry so that the contact information is maintained by the owners of the user profiles. This ensures that the information accessible by a personal directory is always up-to-date and presented in a way desired by the user profile owner. For example, if an owner of a user profile changes his or her phone number or other contact information, this information will automatically be accessible by every other user who has the user profile owner's name in their personal directory even though the other users may be unaware of the user profile owner's new phone number. A separate contact list (both individual and group) is maintained within the registry. The personal directory is stored exclusively in the registry when no client software application is used.

Once a user has added a user profile to his or her personal directory, he or she may directly access the user profile by clicking on the name. This triggers the client software application to establish a communication with the registry 12 over the data channel 32 and triggers the registry to provide the user profile to the user without requiring any of the search functions mentioned above. However, a user is not required to add profiles to a personal directory in order to “click-to-connect.”

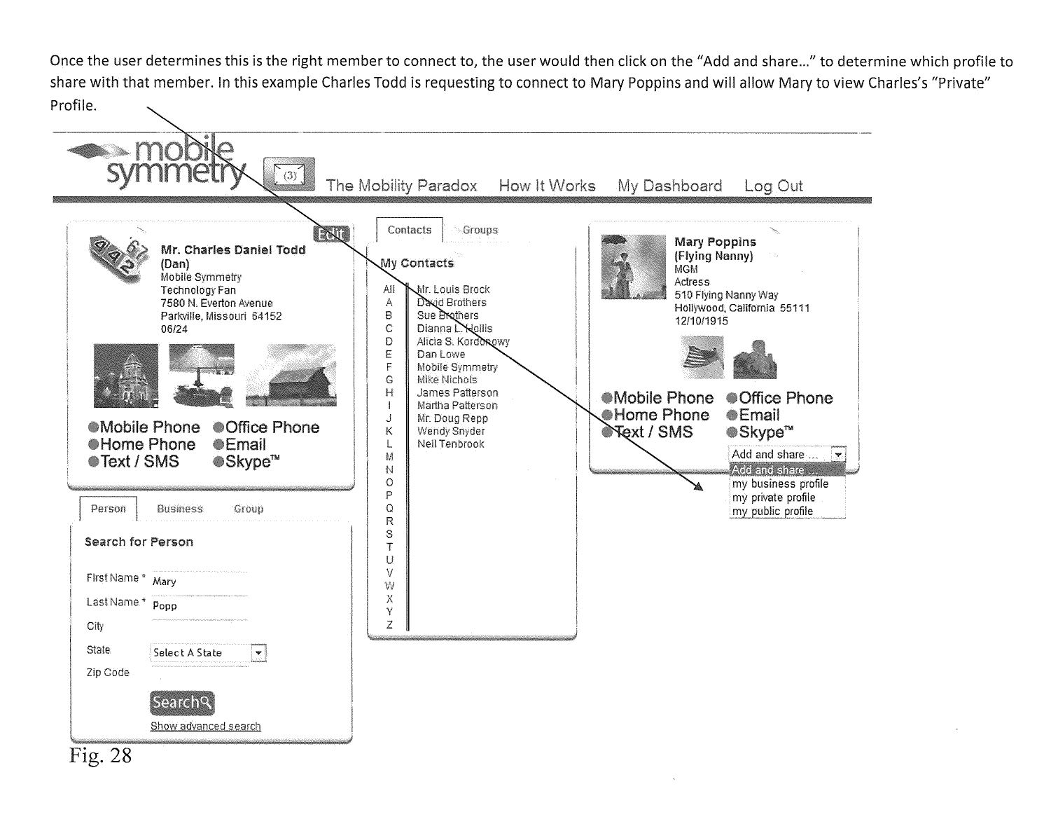

FIG. 5 depicts exemplary steps if a user profile owner requires permission to be contacted. As shown in FIGS. 28-34, a user may open the client software application on his or her mobile communication device, click on Find Someone, submit a look-up request for “Mary Poppins,” and then be presented with an associated user profile. If the user wishes to contact Mary Poppins, the user must click on a Request Permission link as shown in FIG. 28 and depicted by step 502 in FIG. 5. The client software application on the user's mobile communication device may then present a screen that asks how the searching user would like the searched for user to see their profile, and sends an invitation to connect with the searched for user for a private or business view. This same process is followed for the web and WAP application.

Before or after the invitation is sent, the client software application on the requestor's mobile communication device 16a may add the name from the user profile to the requestor's personal directory and mark it as “pending” in step 504, the purpose of which is described below. The same process is followed for the web and WAP application.

The registry 12 then sends an invitation to the message center of the user profile owner via one of the communication methods specified by the user profile owner as depicted in step 506. The user profile owner retrieves the invitation request from the message center in step 508 and either accepts it or rejects it in step 510. If the user profile owner accepts the invitation, the registry 12 modifies the user profile to indicate that the requesting party may contact the user profile owner in the future without requesting permission again. A message is also sent to the requesting party's mobile communication device 16a to update the requestor's personal directory and change the user profile from “pending” to “approved.” As described above, this allows the requestor to access the user profile directly by clicking on the associated name in the personal directory without performing the search functions depicted in FIG. 4.

FIGS. 6a and 6b depict exemplary steps when a user has found a user profile (and been given permission if required) and is ready to contact the owner of the user profile. As mentioned above, contact may be via a mobile communication device call, a text message, an e-mail message, or any other communication delivered over a wireless communication network. For the following example, the contact is assumed to be a mobile communication device call between a calling party (the user who searched for the user profile) and a called party (the owner of the user profile).

The calling party initiates the call in step 602 by clicking on the buttons or links to any of the called party's permitted contact methods in the user profile. The client software application on the calling party's mobile communication device 16a then initiates a mobile communication device call in a conventional manner. The phone call is delivered to the mobile switching center (MSC) that serves the called mobile communication device 16b as depicted in step 604. The MSC then determines in step 606 if a calling name trigger has been set for the called mobile communication device 16b. If the answer is “no,” the method proceeds to steps 608 and 610 where the call is connected to the called party using normal call processing.

However, if a calling name trigger is set in the MSC for the called mobile communication device 16b, the MSC queries the registry to determine if the telephone number or ANI of the calling party is in the registry in steps 612 and 614. If it is not, the method returns to steps 608 and 610 to deliver the call without any calling name information. If the ANI of the calling mobile communication device 16a is in the registry, the registry returns calling name information to the MSC 24 in step 616 and the MSC 24 connects the call to the called mobile communication device 16b using conventional calling name processing in step 618.

The method then determines if a client software application is stored on the called mobile communication device 16b in step 620. If not, the MSC completes the call to the called mobile communication device 16b using normal call processing as depicted in step 622. If, however, a client software application is installed on the called mobile communication device, the client software application is automatically activated upon receipt of the phone call and determines whether the telephone number of the calling mobile communication device 16a is in the called party's resident contact list as depicted in step 624. If it is not, the client software application opens a data channel 34 between the called mobile communication device and the registry 12 in step 626 and queries the registry for the user profile that matches the calling phone number. Even if the telephone number is in the called mobile communication device's 16b resident contact list, the client software application may be configured to query the registry 12 to obtain the full user profile for the calling mobile communication device 16a as depicted in steps 628 and 626.

If the registry 12 does not have a user profile for the user of the calling mobile communication device 16a as determined in step 630, the call is completed without displaying the user profile as depicted in step 632. The registry may then automatically send a message to the owner of the calling mobile communication device 16a to prompt the owner to add a user profile to the registry as depicted in step 634.

If a user profile for the calling mobile communication device 16a is found in the registry 12, the registry 12 returns at least a portion of the user profile to the called mobile communication device 16b as depicted in step 636 and the called mobile communication device displays it in step 638. Importantly, this allows the user of the calling mobile communication device 16a to determine what information gets displayed on the called mobile communication device 16b and how it is presented. For example, if the user of the calling mobile communication device 16a adds a photo to his or her user profile, this photo will be displayed on the called mobile communication device 16b when it receives a call from the calling mobile communication device 16b. With prior art resident contact lists, the owner of each mobile communication device must create contact information and store it in a resident contact list, and only this information is displayed during a phone call.

The registry 12 may also provide an In-Network indicator and Calling Reason indicator to the called mobile communication device if the user profiles for the calling and called mobile communication devices indicate that both are served by the same wireless carrier. This tells the owners of the mobile communication devices that the mobile call is an in-network call.

While the above steps are being performed, the MSC also opens a voice channel between the calling and called mobile communication devices in a conventional manner as depicted in step 640.

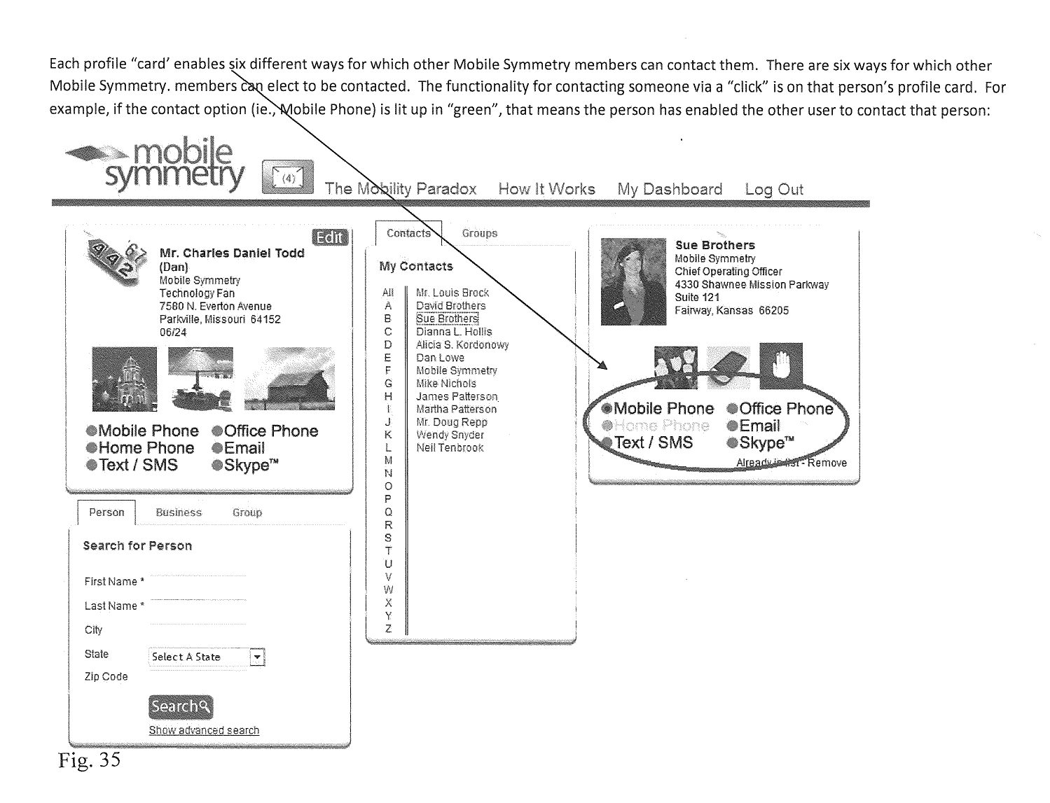

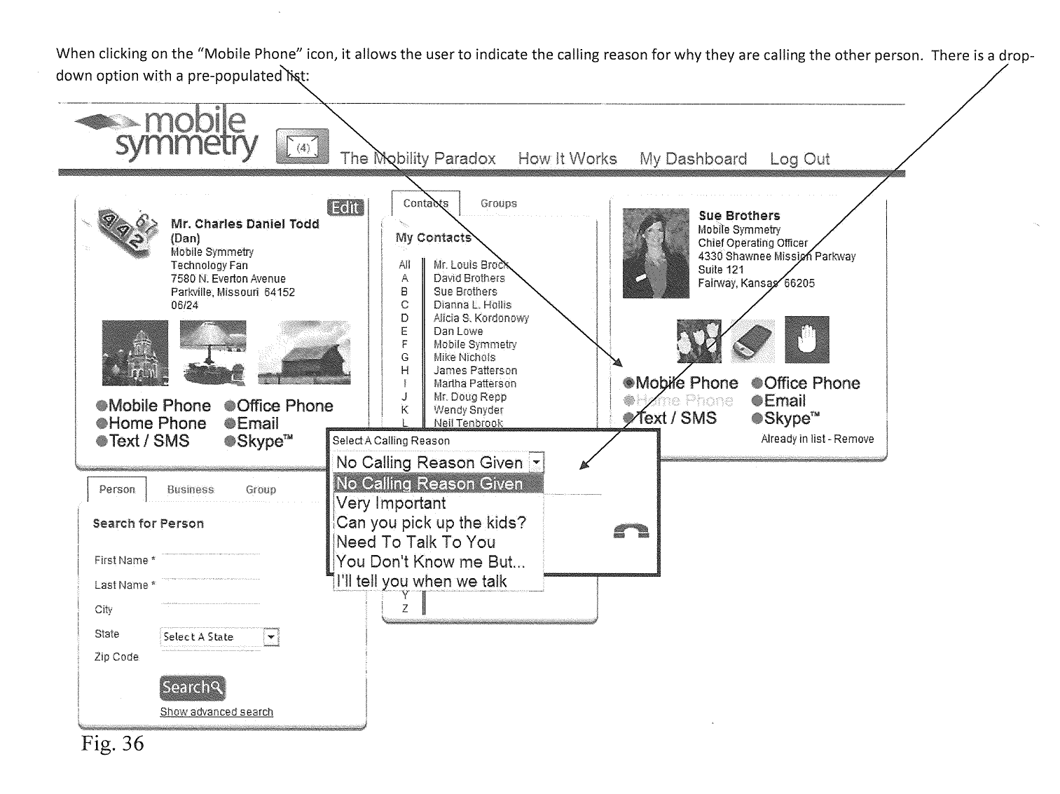

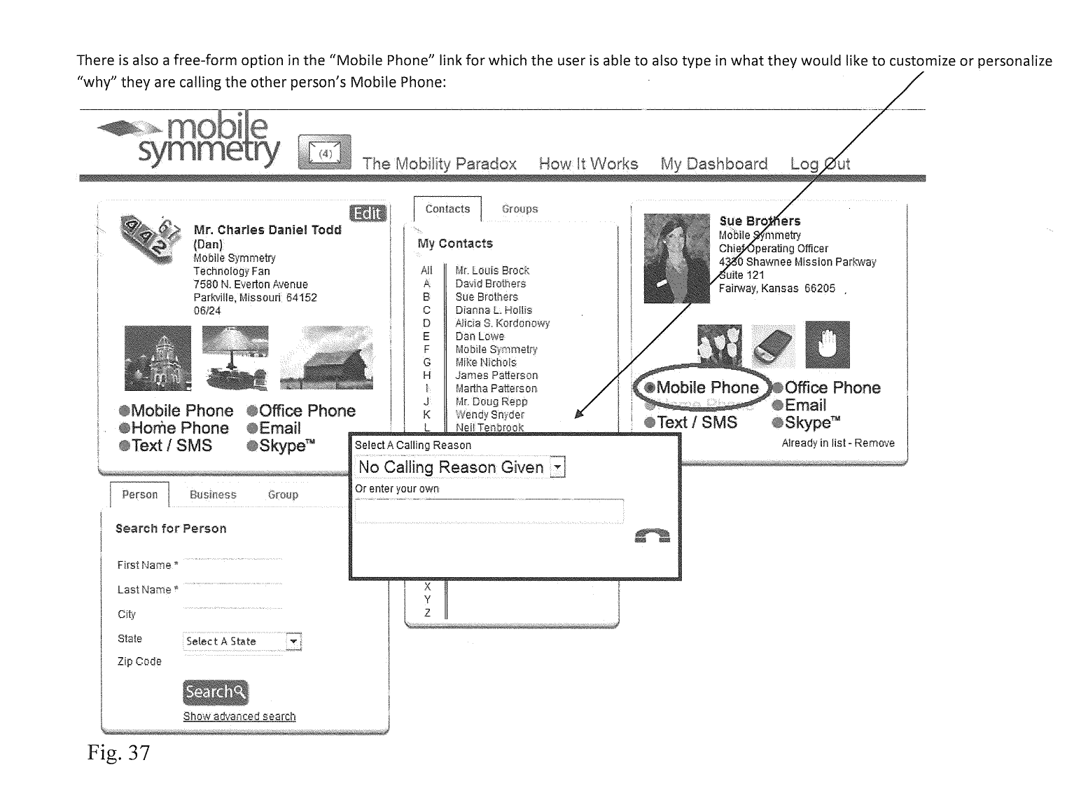

The screen shots of FIGS. 35-43 depict the click-to-connect functionality of the invention in more detail. Each user profile may indicate how the user wishes to be contacted. For example, as illustrated in FIG. 35, the user Alicia Kordonowy may be contacted by mobile phone, home phone, text/SMS, office phone, e-mail, or Skype. The user may enable some or all of these contact methods. For example, in one embodiment, contact methods that are bolded, colored, or otherwise highlighted are enabled, whereas contact methods that are not highlighted are not enabled. FIGS. 36 and 37 show how a calling party may indicate a Calling Reason when placing a call from a user profile. The screen may provide several pre-populated Callings Reasons as shown.

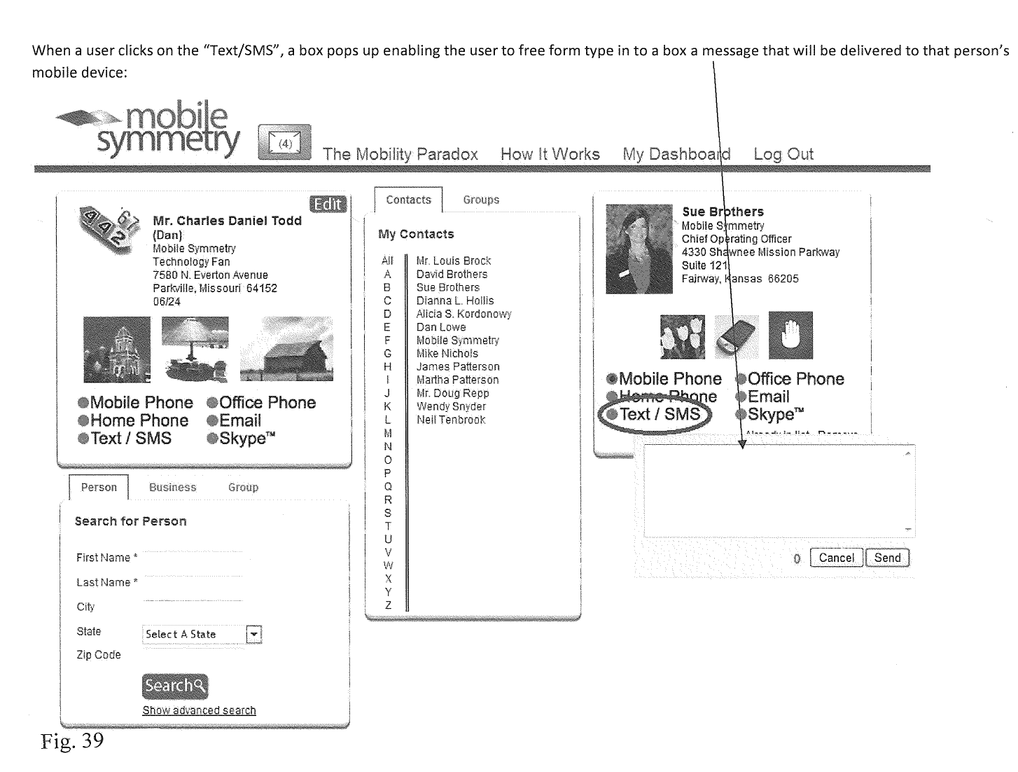

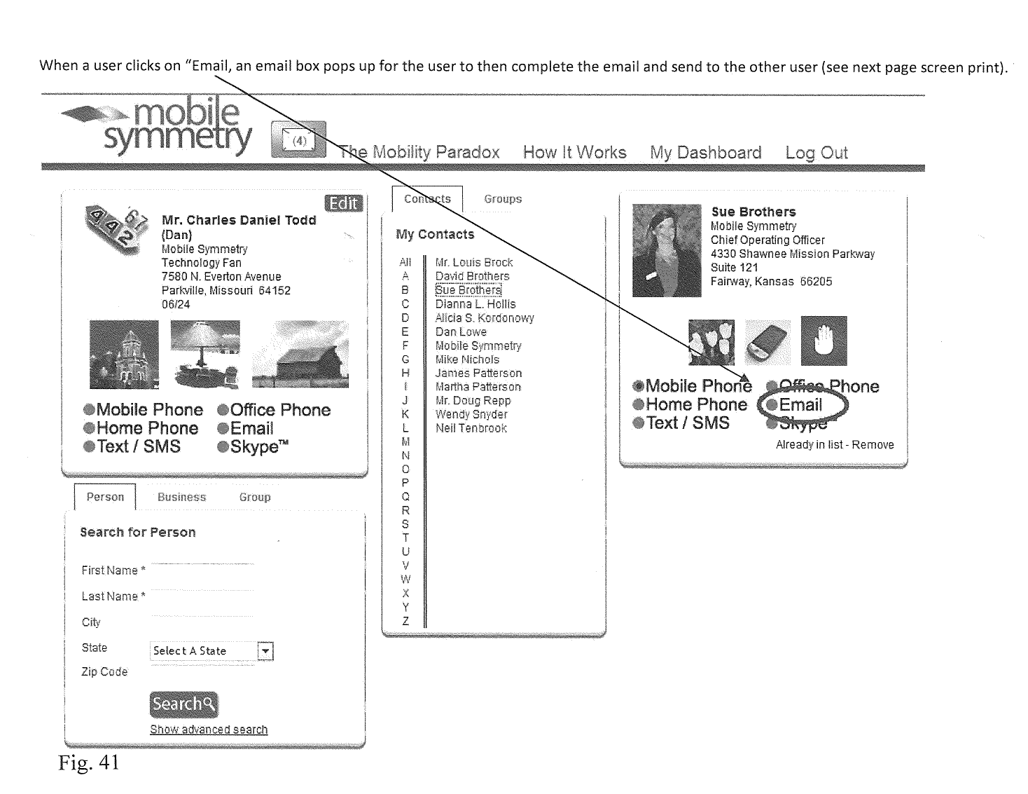

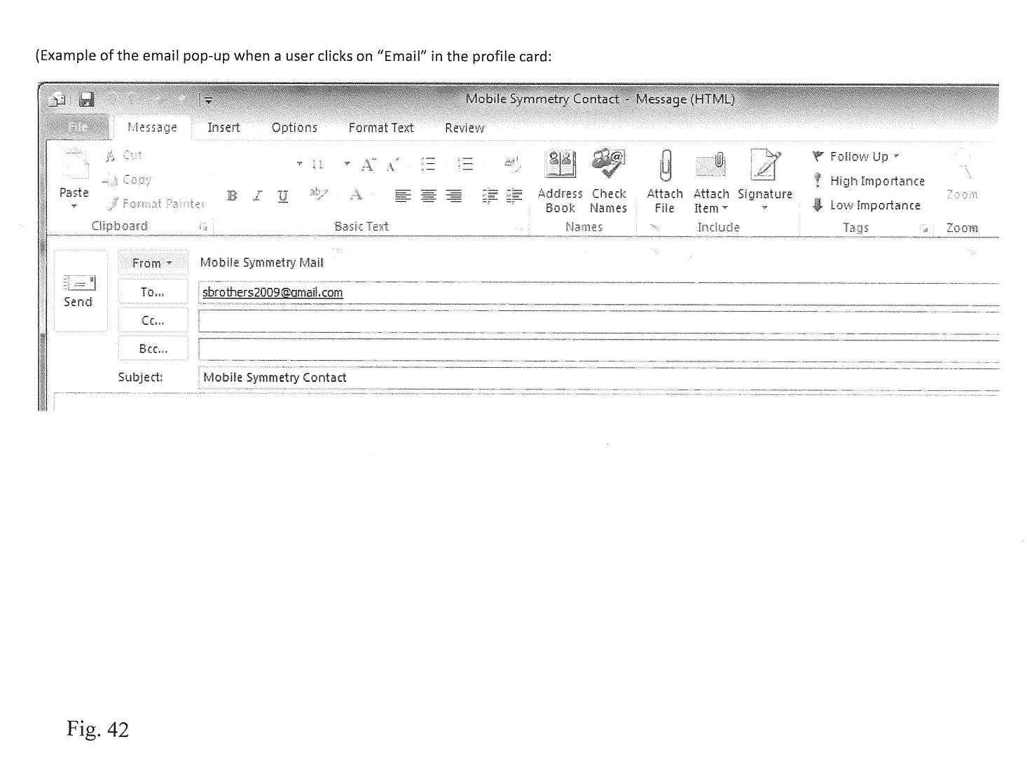

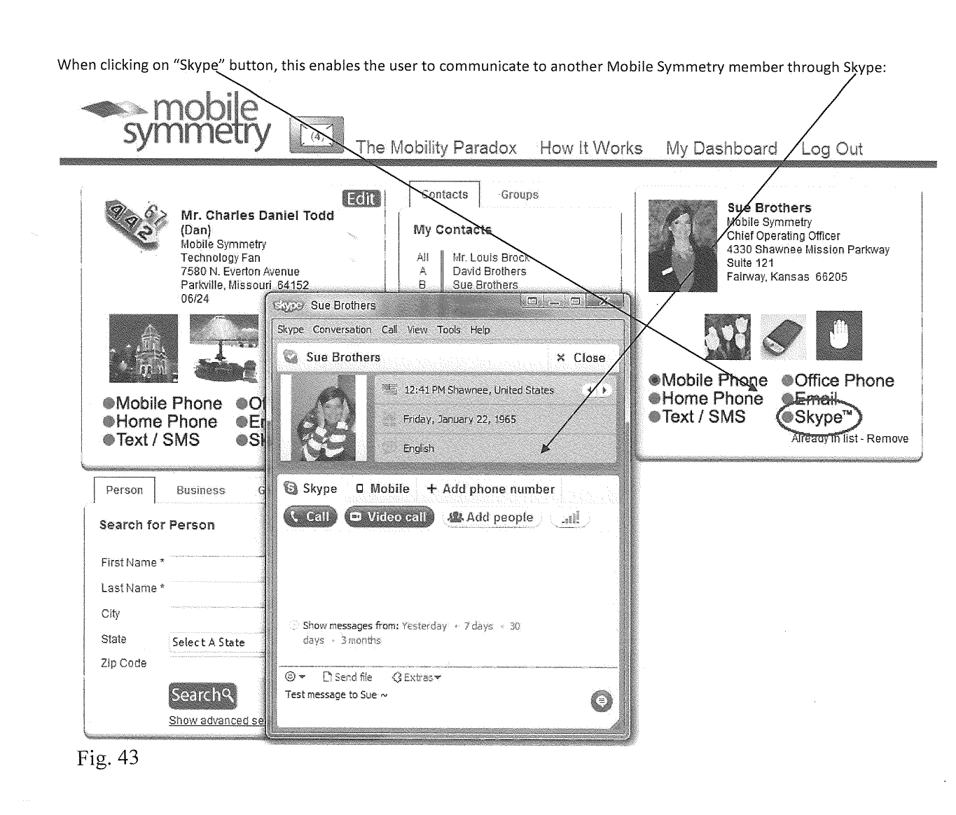

When a user clicks on the Text/SMS contact method, a message box is displayed for the text as shown in FIG. 39. A similar box is displayed for e-mail messages as shown in FIGS. 41 and 42. FIG. 43 illustrates a communication made with Skype. Regardless of if the user clicks to a text, e-mail, or Skype connection, a communication is generated over the appropriate medium, which connects both users. For text, e-mail, or Skype communications, the initial communication is established by the searching party to be replied to by the searched party.

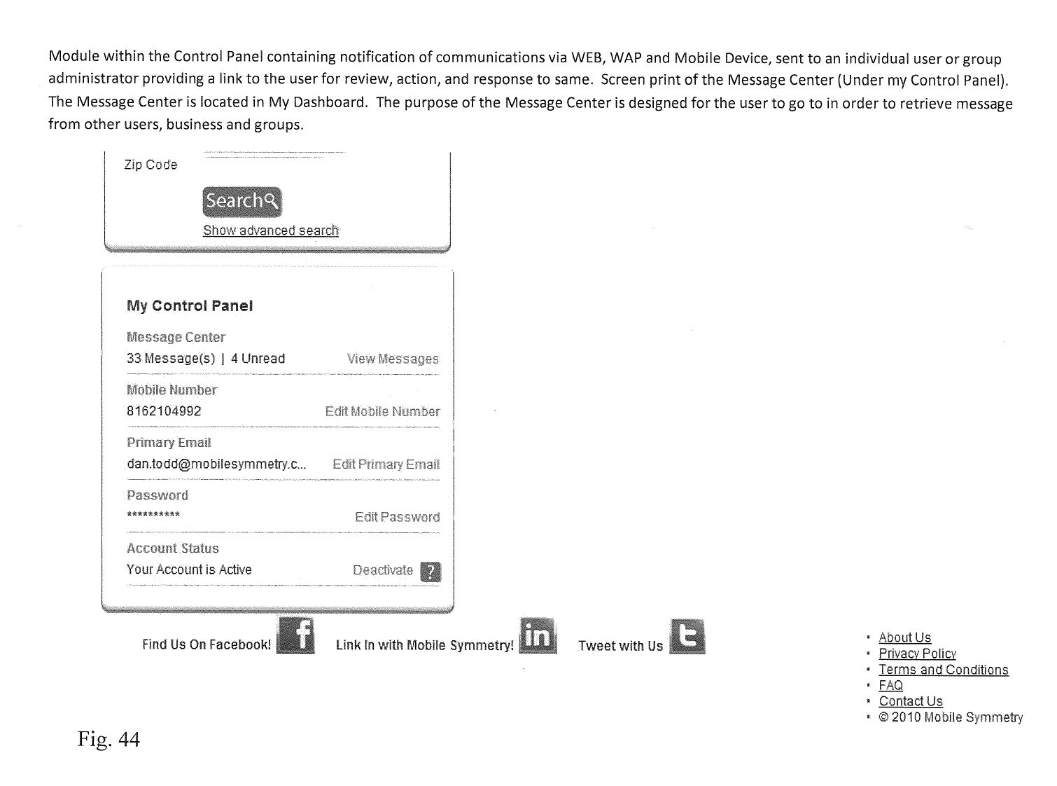

FIGS. 44-47 depict a Message Center functionality of the invention in more detail. The registry includes a Message Center module for each profile owner accessible within the user's Control Panel. A user may access his or her Message Center to retrieve messages from other users, businesses, and/or groups. The user's Message Center houses all requests for a user to view and approve or deny any contact request, child or minor requests, group directory request, and any other form of intra database requests from another user or directory. The Message Center also houses the ability to edit fields which are not editable within the normal edit process, e.g. mobile number, primary e-mail and password, and to change the status of an account between active, inactive, or cancelled.

Although the invention has been described with reference to the preferred embodiment illustrated in the attached drawing figures, it is noted that equivalents may be employed and substitutions made herein without departing from the scope of the invention as recited in the claims. For example, although a client software application as described above is preferably loaded on every mobile communication device that uses the registry, this is not required as mobile communication devices and other computing devices without the software application may still access the registry with a web browser to search for a user profile. Similarly, the software application is not required to create and post a user profile on the registry. However, the software application is currently necessary to obtain and display a user profile for an incoming call.

Having thus described the preferred embodiment of the invention, what is claimed as new and desired to be protected by Letters Patent includes the following:

1. A method of providing contact information for mobile communication devices, the method comprising the steps of:
maintaining a registry of user profiles established and maintained by mobile communication device users, wherein each user profile includes data representative of a user's name and mobile communication device number;
receiving at the registry a look-up request from a calling mobile communication device;
accessing the registry and locating a user profile that matches the look-up request; and
providing information from the matched user profile to the calling mobile communication device for display thereon.

2. The method as set forth in claim 1, wherein the information provided to the calling mobile communication device permits display of the name in the user profile but not the mobile communication device number in the user profile.

3. The method as set forth in claim 1, wherein each user profile includes permission information that enables each user to determine who may contact them.

4. The method as set forth in claim 1, wherein the look-up request is transmitted to the registry over a data channel and is generated with a client software application operating on the calling mobile communication device or is generated via a web or WAP access to the registry.

5. The method as set forth in claim 1, wherein the look-up request includes a name and a geographic location of a person.

6. The method as set forth in claim 1, further including the step of determining a strength of each user profile and providing an indication of the strength to each user.

7. The method as set forth in claim 6, wherein the strength of each user profile is a measure of a uniqueness of the user profile.

8. The method as set forth in claim 1, further including the steps of receiving from a called mobile communication device data representative of the phone number of the calling mobile communication device; accessing the registry and retrieving a user profile for the calling mobile communication device; and providing to the called mobile communication device information from the user profile for the calling mobile communication device.

9. A method of establishing a mobile communication device call between a calling mobile communication device and a called mobile communication device, the method comprising:
receiving from the calling mobile communication device a look-up request for a user of the called mobile communication device, wherein the look-up request is generated via a web or WAP access or with a client software application operating on the calling mobile communication device and is transmitted over a data channel before a voice channel has been established between the calling mobile communication device and the called mobile communication device;
accessing a registry and obtaining contact information for the called mobile communication device in response to the look-up request;
providing the contact information for the called mobile communication device to the calling mobile communication device over the data channel or via the web or WAP access; and
permitting the calling mobile communication device to establish a communication with the called mobile communication device with the contact information.

10. The method as set forth in claim 9, wherein the registry includes a plurality of user profiles established and maintained by mobile communication device users, each user profile including information representative of a mobile communication device user's name and mobile communication device number.

11. The method as set forth in claim 10, wherein each user profile includes permission information that enables each user to determine who may contact them.

12. The method as set forth in claim 9, further including the steps of transmitting to the called mobile communication device information that identifies a reason for the call during or after establishment of a voice channel between the calling mobile communication device and the called mobile communication device.

13. The method as set forth in claim 9, further including the step of determining if the calling mobile communication device and the called mobile communication device are both served by the same wireless phone carrier, and if so, transmitting information to the called mobile communication device to indicate such.

14. The method as set forth in claim 9, further including the steps of receiving from the called mobile communication device data representative of the calling mobile communication device number as a voice channel is being established between the calling mobile communication device and the called mobile communication device; accessing the registry and retrieving a user profile for the calling mobile communication device; and providing to the called mobile communication device information from the user profile for the calling mobile communication device.

15. A system for providing contact information for mobile communication device users, the system comprising:
a registry for storing user profiles created and maintained by a plurality of mobile communication device users, each user profile having information representative of user's name and mobile communication device number;
a first computer program stored on memory associated with the registry, the first computer program comprising
a code segment for receiving a look-up request from a calling mobile communication device;
a code segment for accessing the central registry and obtaining contact information for a called mobile communication device that matches the look-up request; and
a code segment for providing the contact information for the called mobile communication device to the calling communication device; and
a second computer program stored on memory of the calling mobile communication device, the second computer program comprising
a code segment for generating the look-up request and transmitting it to the registry;
a code segment for receiving the contact information for the called mobile communication device; and
a code segment for initiating a communication between the calling mobile communication device and the called mobile communication device using the contact information.

16. The system as set forth in claim 15, the second computer program further including a code segment for transmitting information that identifies a reason for a call to the called mobile communication device during or after establishment of the voice channel between the calling mobile communication device and the called mobile communication device.

17. The system as set forth in claim 15, the first computer program further including a code segment for determining if the calling mobile communication device and the called mobile communication device are both served by the same wireless phone carrier, and if so, transmitting information to the called mobile communication device to indicate such.

18. The system as set forth in claim 15, the first computer program further including code segments for receiving from the called mobile communication device data representative of the phone number of the calling mobile communication device as a voice channel is being established between the calling mobile communication device and the called mobile communication device; accessing the registry and retrieving a user profile for the calling mobile communication device; and providing to the called mobile communication device information from the user profile for the calling mobile communication device.
